(19) United States
(12) Patent Application Publication
(10) Pub. No.: US 2022/0215659 A1
(43) Pub. Date: Jul. 7, 2022

(54) IMPUTATION OF REMOTE SENSING TIME SERIES FOR LOW-LATENCY AGRICULTURAL APPLICATIONS

(71) Applicant: Indigo Ag, Inc., Boston, MA (US)

(72) Inventors: Eli Kellen Melaas, Boston, MA (US); Elisabeth Florence Ilona Baldo, Somerville, MA (US); Bobby Harold Braswell, Portsmouth, NH (US)

(21) Appl. No.: 17/704,622

(22) Filed: Mar. 25, 2022

Related U.S. Application Data
(63) Continuation of application No. PCT/US20/52755, filed on Sep. 25, 2020.
(60) Provisional application No. 62/945,745, filed on Dec. 9, 2019.
(60) Provisional application No. 62/907,346, filed on Sep. 27, 2019.

(51) Int. Cl. G06V 20/10; G06T 3/40; A01B 79/00

(52) U.S. Cl. CPC G06V 20/188; A01B 79/005; G06T 3/4053

(57) ABSTRACT

Imputation of remote sensing time series for low-latency agricultural applications is provided. In various embodiments, a first time series of raster data is read. The first time series spans a geographic region and has a first resolution and a first frequency. A second time series of raster data is read. The second time series spans the geographic region and has a second resolution and a second frequency. The second resolution is lower than the first resolution. The second frequency is higher than the first frequency. A mean time series is determined from the first time series of raster data. A predicted time series of values for a location within the geographic region is determined at the first resolution by determining a first time series of values for the location from the first time series of raster data, determining a second time series of values of the location from the second time series of raster data, and determining the predicted time series by multiple linear regression with the first time series dependent on the mean time series and the second time series.

### CROSS-REFERENCE TO RELATED APPLICATIONS

This application is a continuation of International Application No. PCT/US2020/052755, filed Sep. 25, 2020, which claims the benefit of U.S. Provisional Application No. 62/907,346, filed Sep. 27, 2019 and U.S. Provisional Application No. 62/945,745, filed Dec. 9, 2019, each of which is hereby incorporated by reference in its entirety.

### BACKGROUND

Embodiments of the present disclosure relate to remote sensing data analysis, and more specifically, to imputation of remote sensing time series for low-latency agricultural applications.

### BRIEF SUMMARY

According to embodiments of the present disclosure, methods of and computer program products for agricultural index prediction are provided. A first time series of raster data is read. The first time series spans a geographic region and has a first resolution and a first frequency. A second time series of raster data is read. The second time series spans the geographic region and has a second resolution and a second frequency. The second resolution is lower than the first resolution. The second frequency is higher than the first frequency. A mean time series is determined from the first time series of raster data. A predicted time series of values for a location within the geographic region is determined at the first resolution by determining a first time series of values for the location from the first time series of raster data, determining a second time series of values of the location from the second time series of raster data, and determining the predicted time series by multiple linear regression with the first time series dependent on the mean time series and the second time series.

In various embodiments, the mean time series is smoothed. In various embodiments, the predicted time series of values is smoothed.

In various embodiments, each of the first time series of raster data, the second time series of raster data, the mean time series, and the predicted time series correspond to an agricultural index. In some embodiments, the agricultural index comprises normalized difference vegetation index, land surface water index, or and mean brightness.

In various embodiments, a crop type mask is read and determining the mean time series comprises masking the first time series of raster data according to the crop type mask. In various embodiments, a plurality of crop type masks is read, a plurality of mean time series is determined from the first time series of raster data, each mean time series corresponding to one of the plurality of crop type masks, and determining each mean time series comprises masking the first time series of raster data according to the respective crop type mask.

In various embodiments, determining the mean time series comprises selecting the mean time series from the plurality of mean time series. In various embodiments, determining the mean time series comprises selecting one of the plurality of mean time series most similar to the first time series of values. In some embodiments, a crop type associated with the selected one of the plurality of mean time series is determined.

In various embodiments, a time shift is applied to the mean time series based on the first time series. In some embodiments, the time shift is determined by cross-correlation between the mean time series and the first time series.

In various embodiments, the second time series is rescaled. In some embodiments, rescaling the second time series comprises CDF matching.

BRIEF DESCRIPTION OF THE SEVERAL VIEWS OF THE DRAWINGS

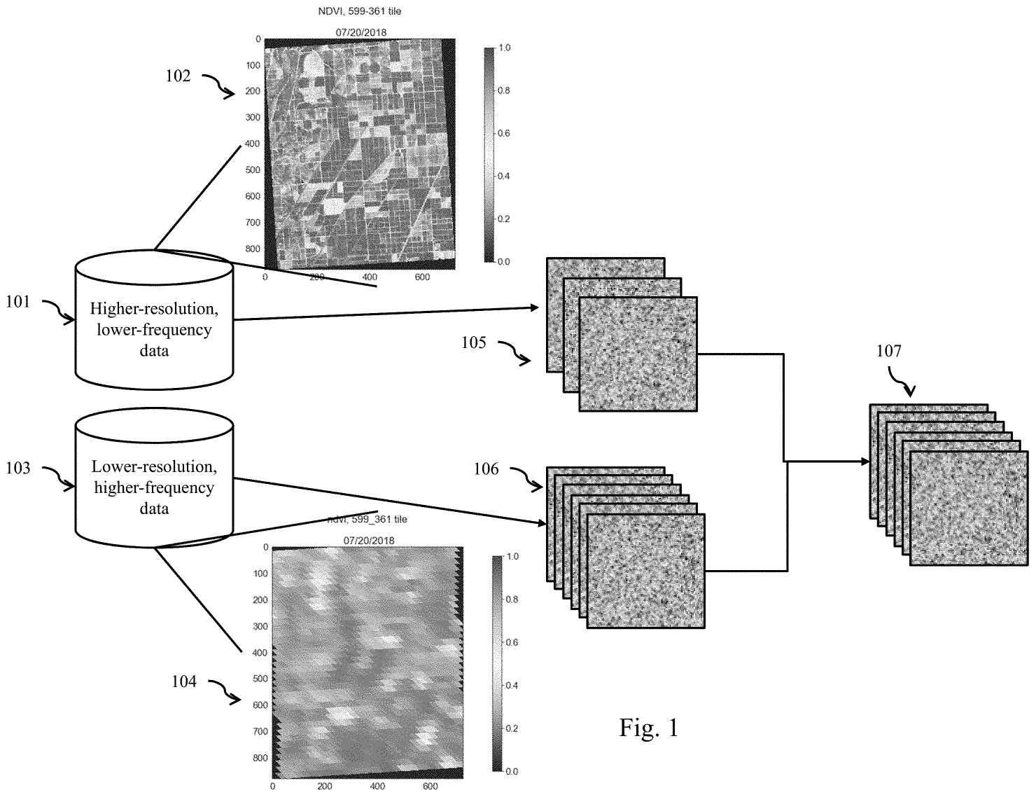

FIG. 1 illustrates a general process for imputation of remote sensing time series according to embodiments of the present disclosure.

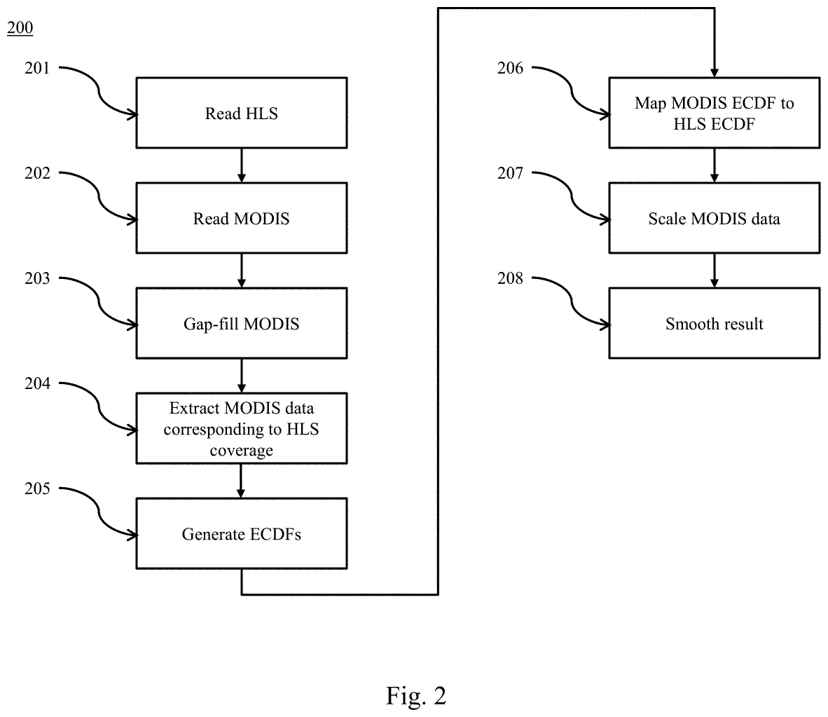

FIG. 2 illustrates a method of generating an imputed series according to embodiments of the present disclosure.

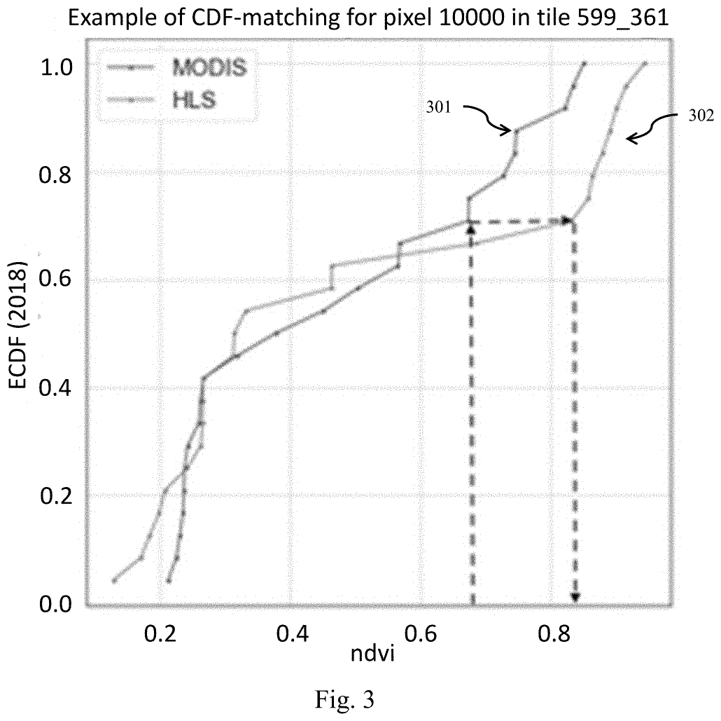

FIG. 3 illustrates an example of CDF matching for a given pixel according to embodiments of the present disclosure.

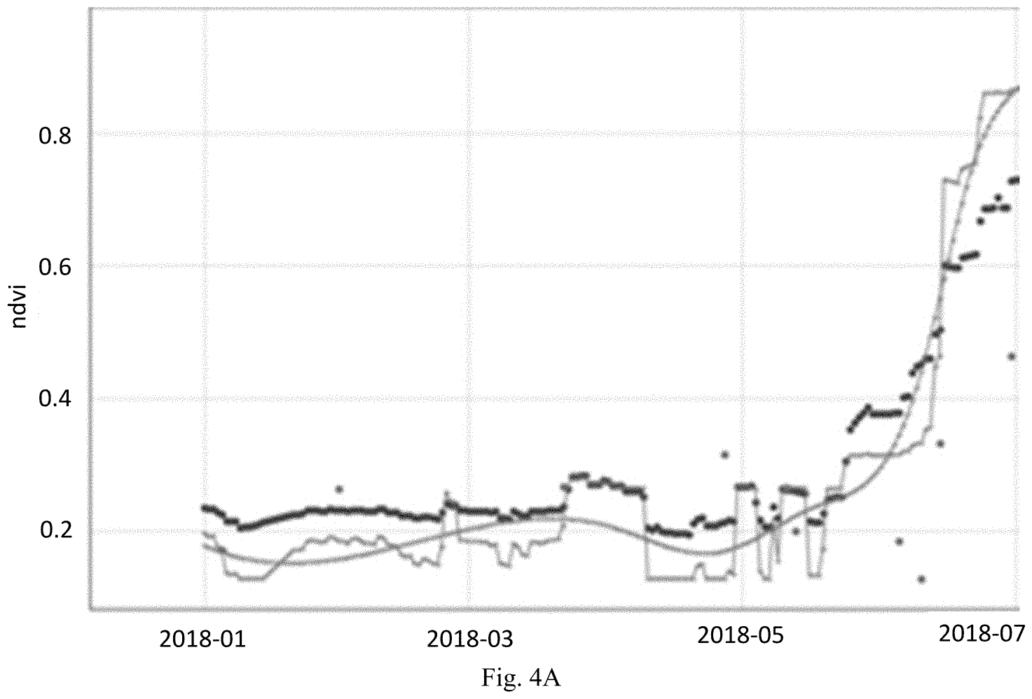

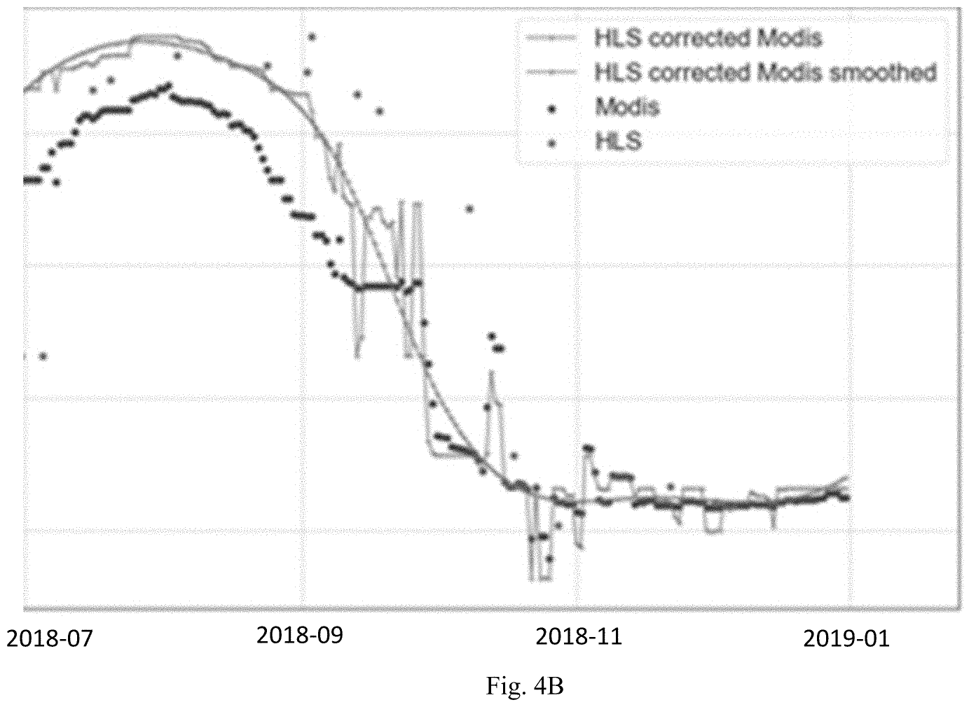

FIGS. 4A-B is a graph of NDVI over time as observed and as derived for a given pixel according to embodiments of the present disclosure.

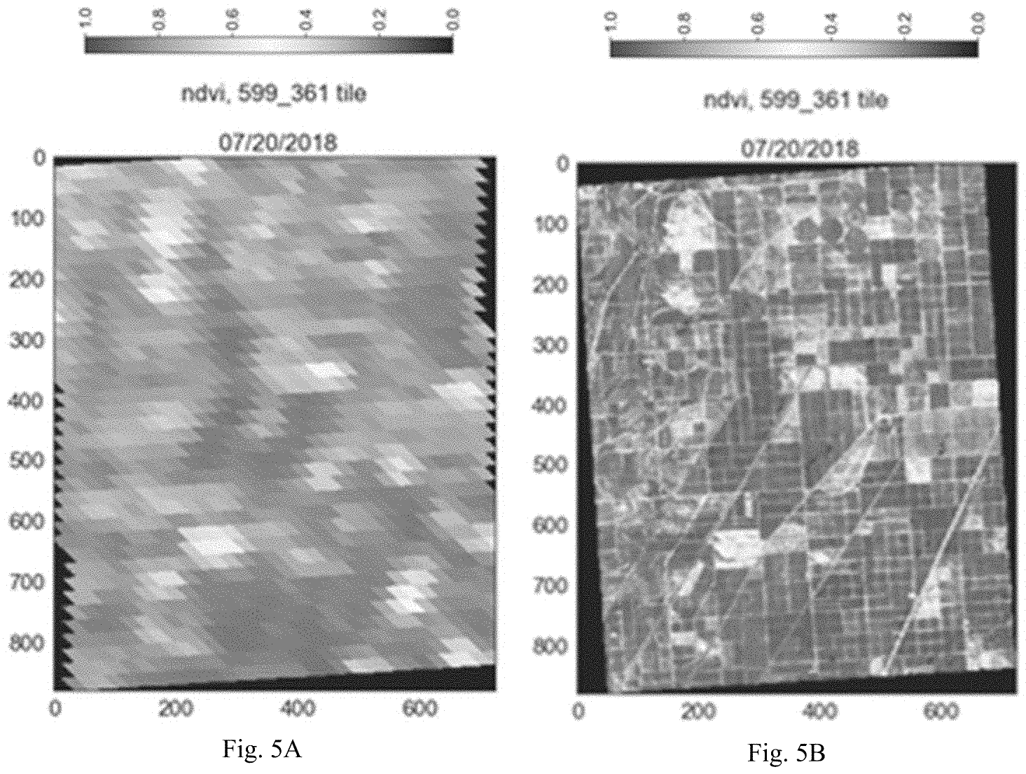

FIG. 5A shows raw MODIS NDVI for an exemplary region according to embodiments of the present disclosure.

FIG. 5B shows the corresponding corrected MODIS NDVI according to embodiments of the present disclosure.

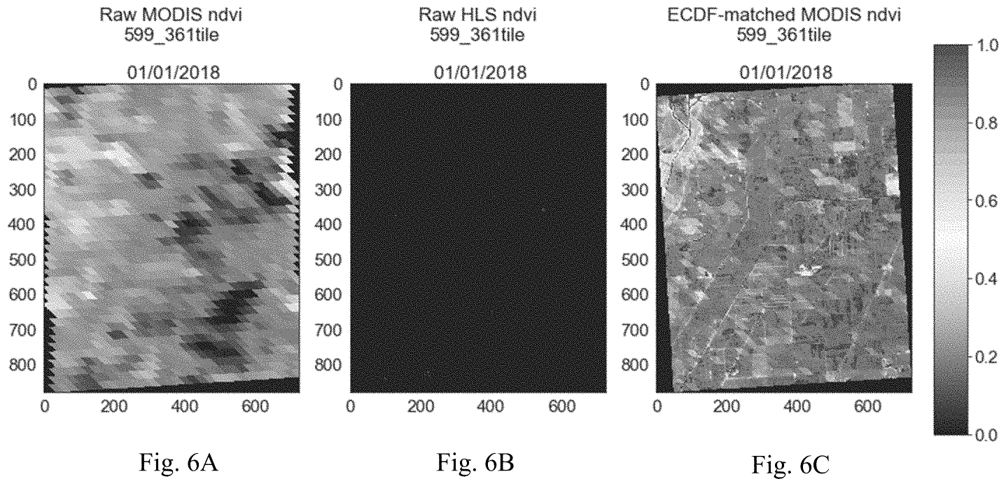

FIG. 6A shows raw MODIS NDVI for the same exemplary region according to embodiments of the present disclosure.

FIG. 6B shows corresponding raw HLS NDVI according to embodiments of the present disclosure.

FIG. 6C shows the ECDF-matched MODIS NDVI according to embodiments of the present disclosure.

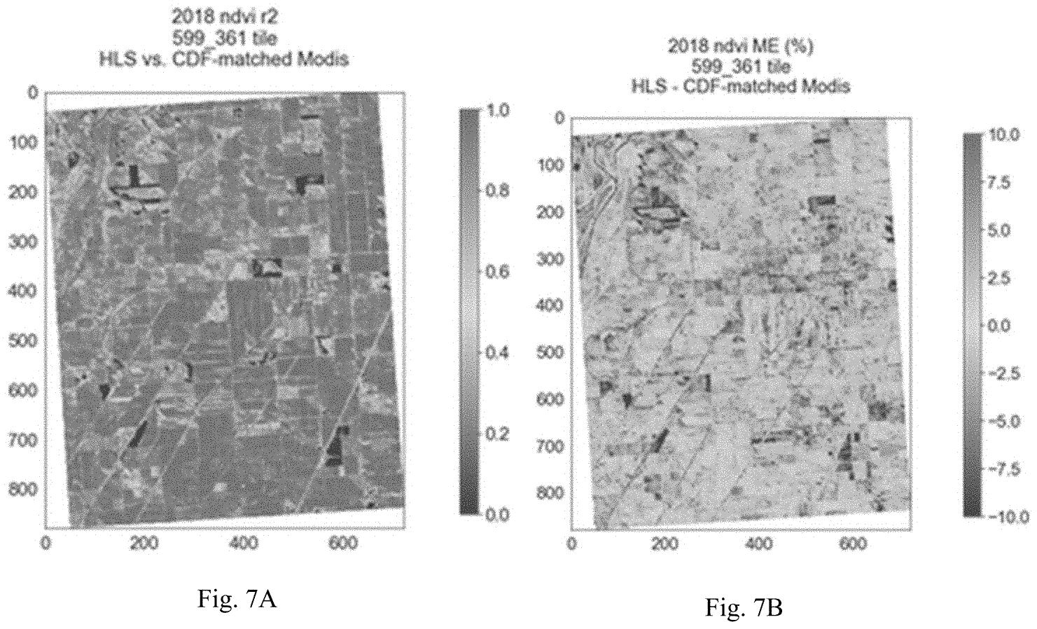

FIG. 7A shows the r² values for HLS versus CDF-matched MODIS NDVI according to embodiments of the present disclosure.

FIG. 7B shows the corresponding mean error according to embodiments of the present disclosure.

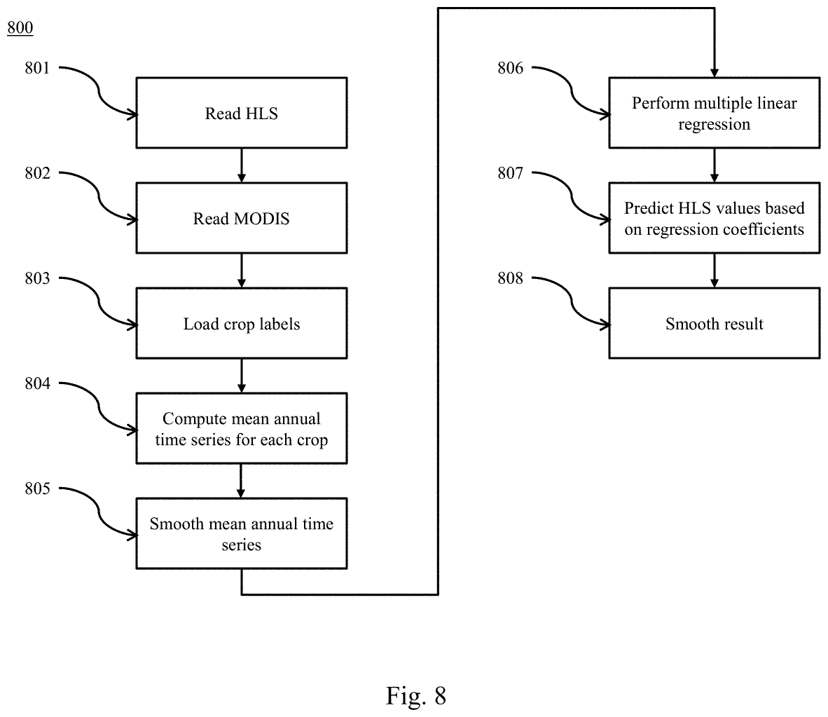

FIG. 8 illustrates a method of generating an imputed series according to embodiments of the present disclosure.

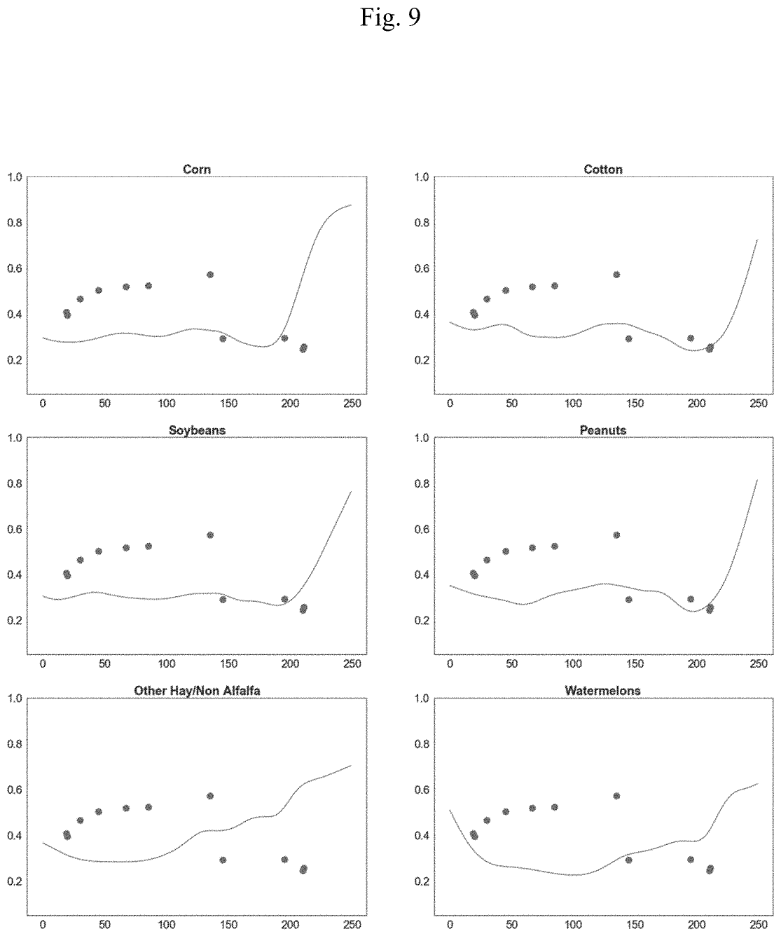

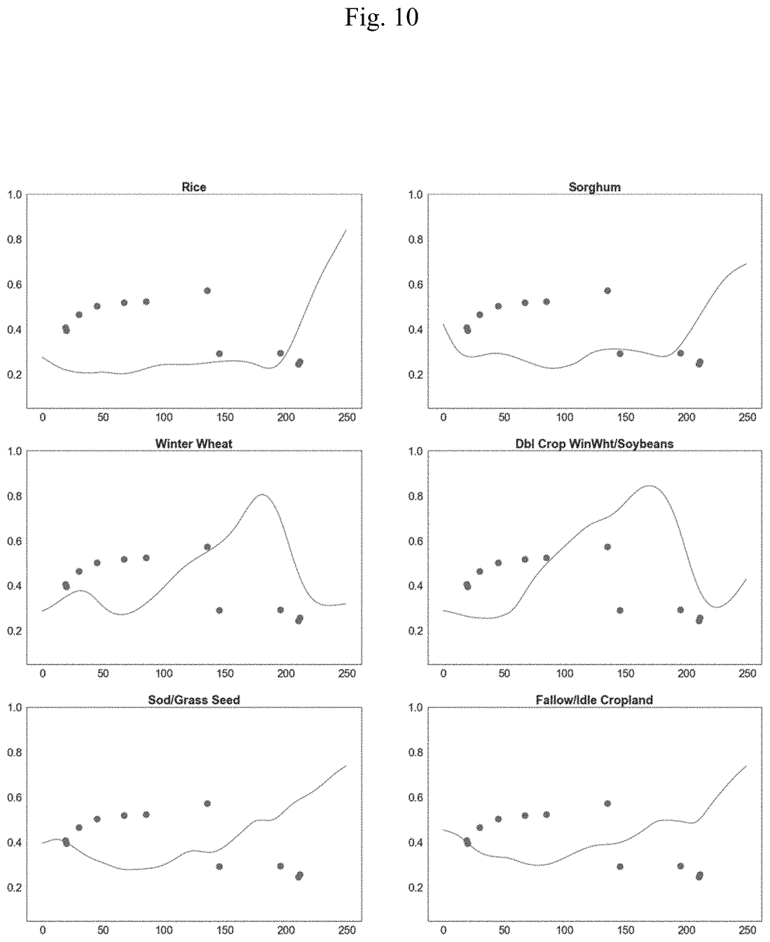

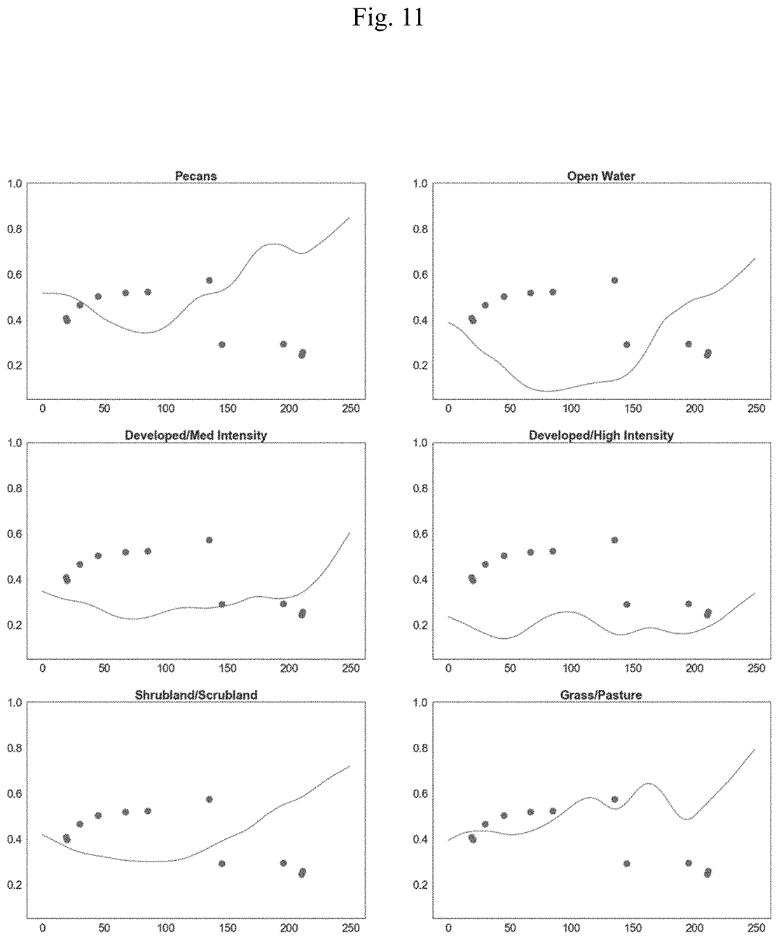

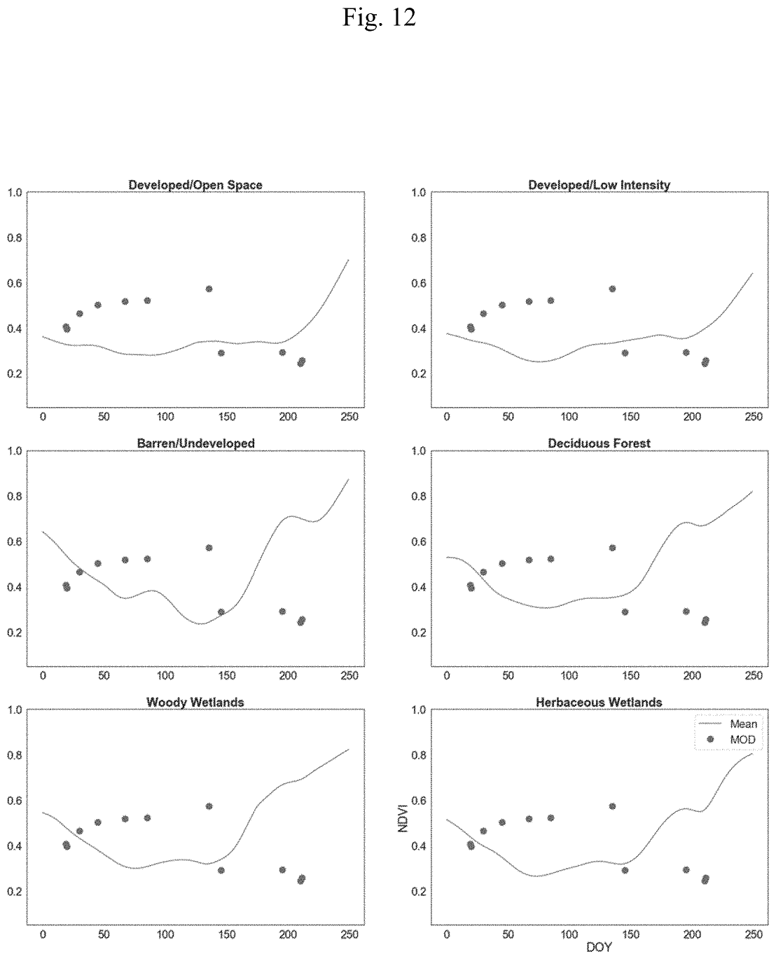

FIGS. 9-12 show exemplary mean annual time series for a plurality of exemplary crop types according to embodiments of the present disclosure.

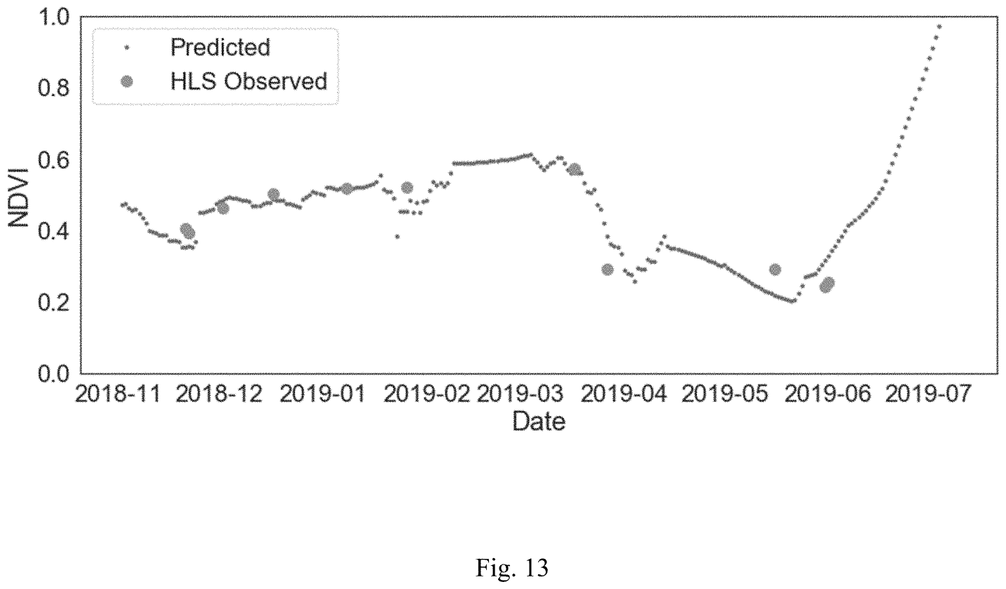

FIG. 13 shows exemplary predicted HLS values according to embodiments of the present disclosure.

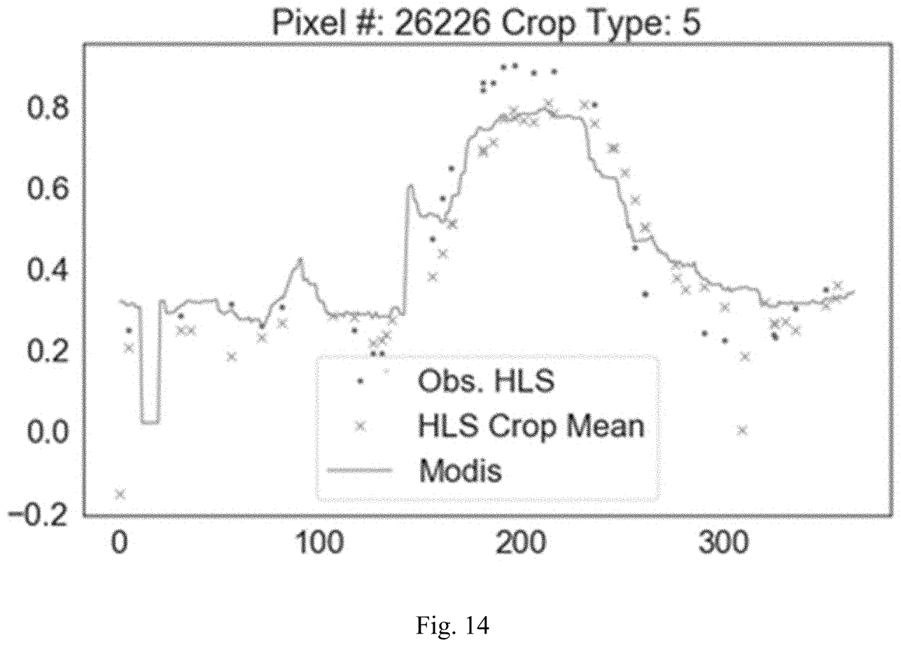

FIG. 14 is a graph of NDVI over time as observed and as derived for a given pixel and a given crop according to embodiments of the present disclosure.

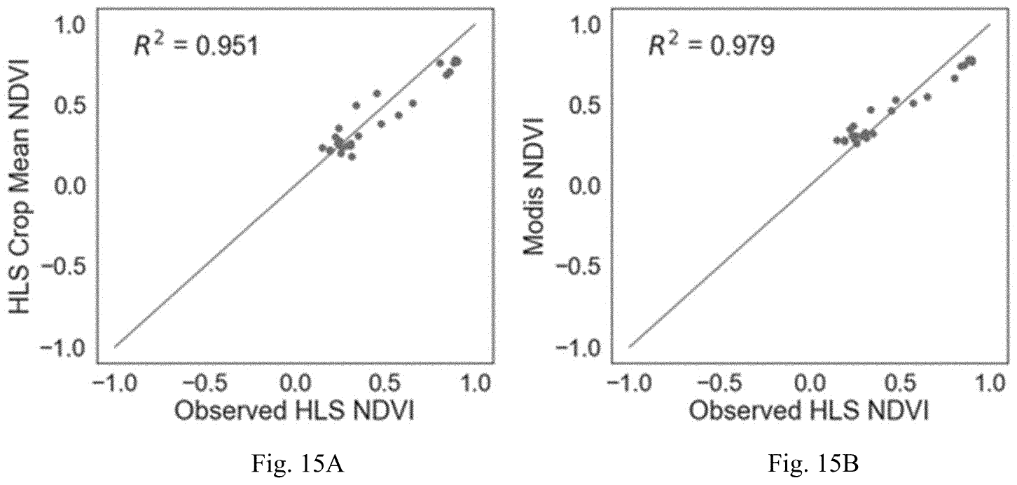

FIG. 15A is a graph illustrating the correlation between HLS observations of NDVI and mean crop time series according to embodiments of the present disclosure.

FIG. 15B is a graph illustrating the correlation between HLS observations of NDVI and co-located MODIS observations according to embodiments of the present disclosure.

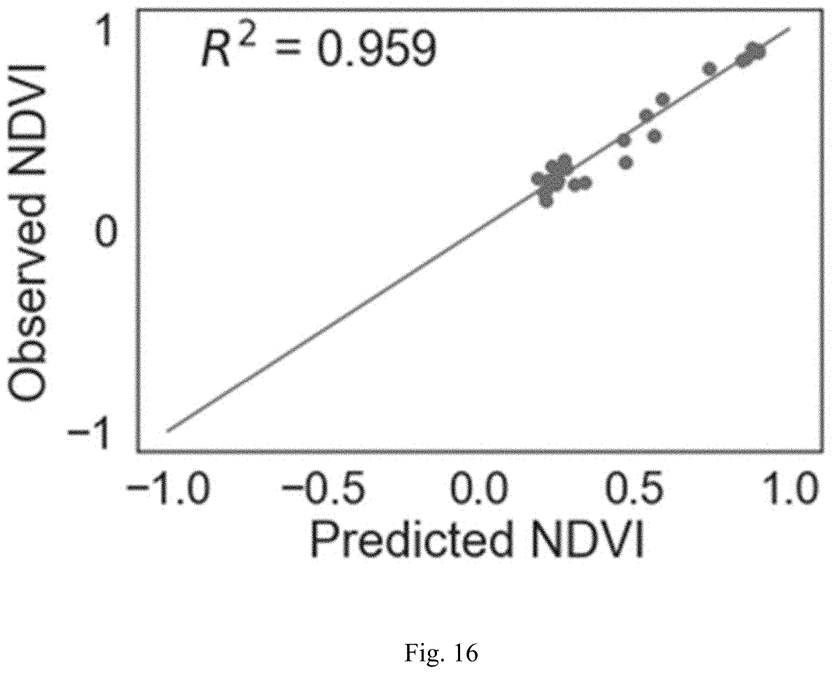

FIG. 16 is a graph illustrating the observed versus predicted HLS NDVI based on multiple regression coefficients according to embodiments of the present disclosure.

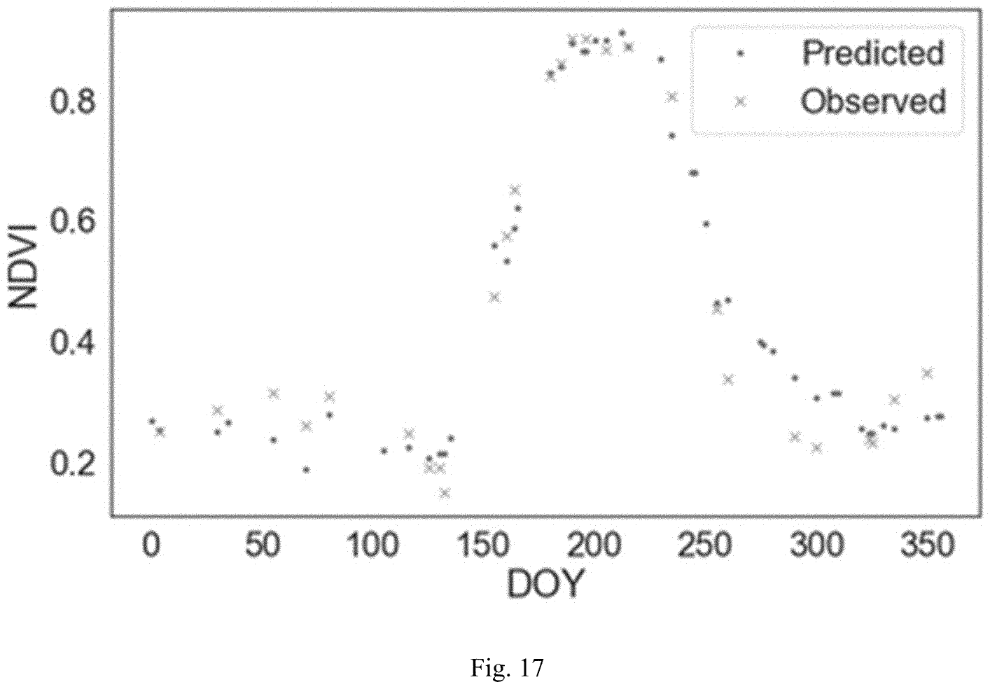

FIG. 17 is a graph illustrating the observed versus HLS NDVI time series according to embodiments of the present disclosure.

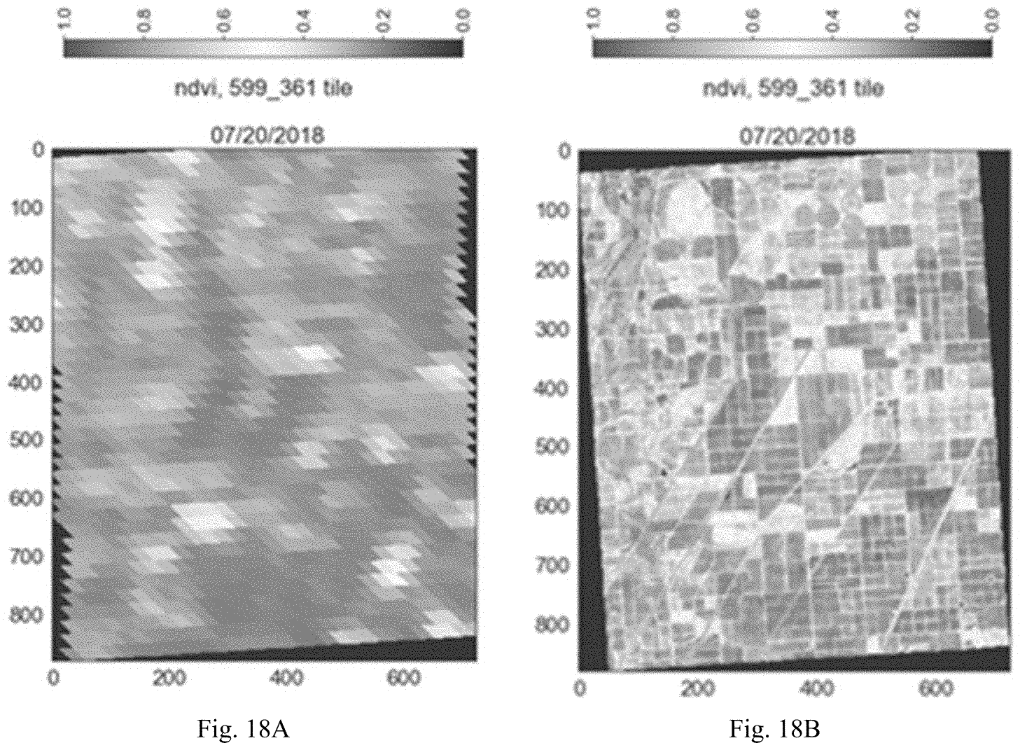

FIG. 18A shows raw MODIS NDVI for an exemplary region according to embodiments of the present disclosure.

FIG. 18B shows the corresponding corrected MODIS NDVI according to embodiments of the present disclosure.

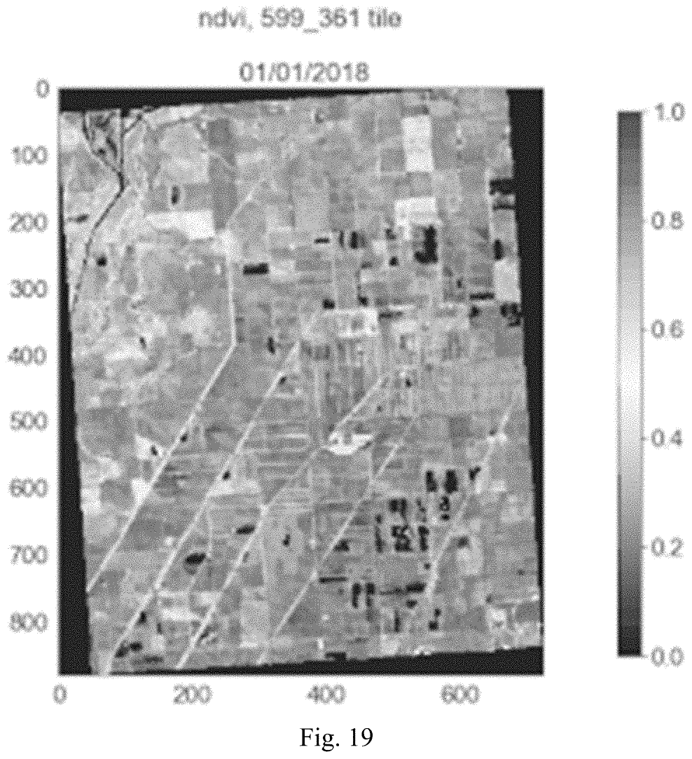

FIG. 19 shows raw corrected NDVI for the same exemplary region according to embodiments of the present disclosure.

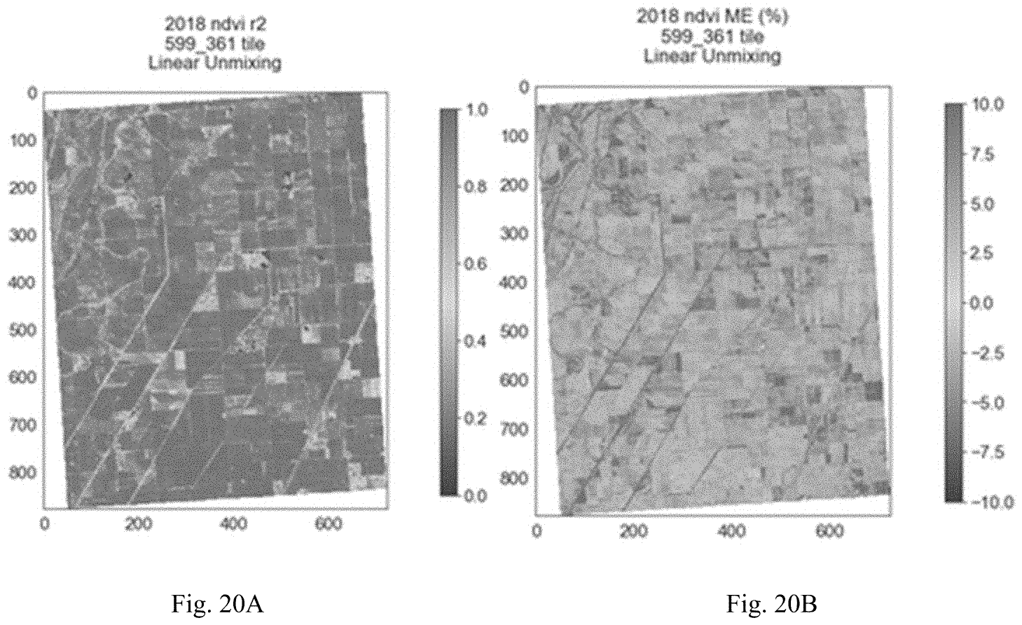

FIG. 20A shows the r² values for HLS versus linear unmixing NDVI according to embodiments of the present disclosure.

FIG. 20B shows the corresponding mean error according to embodiments of the present disclosure.

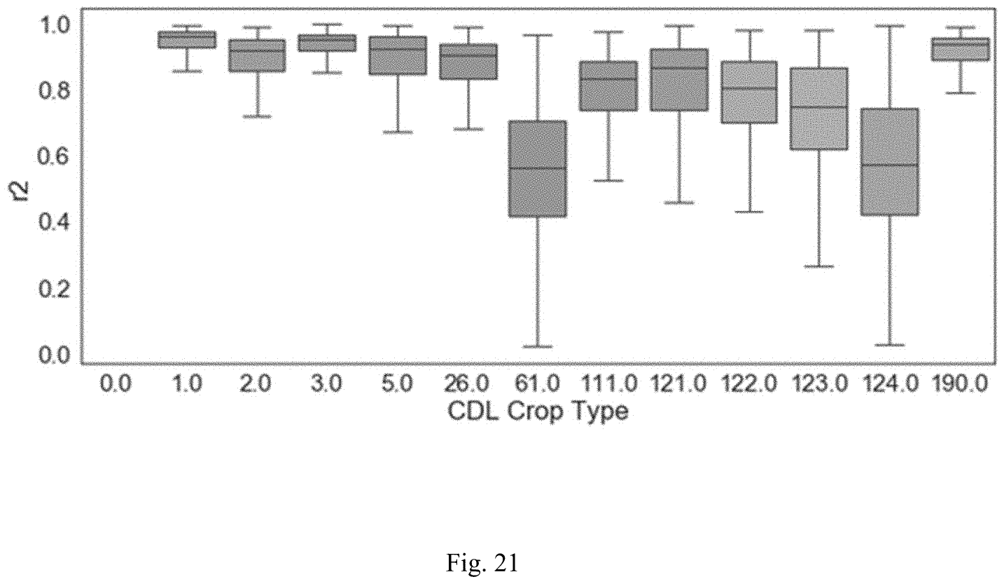

FIG. 21 shows error bars for r² over multiple exemplary crop types according to embodiments of the present disclosure.

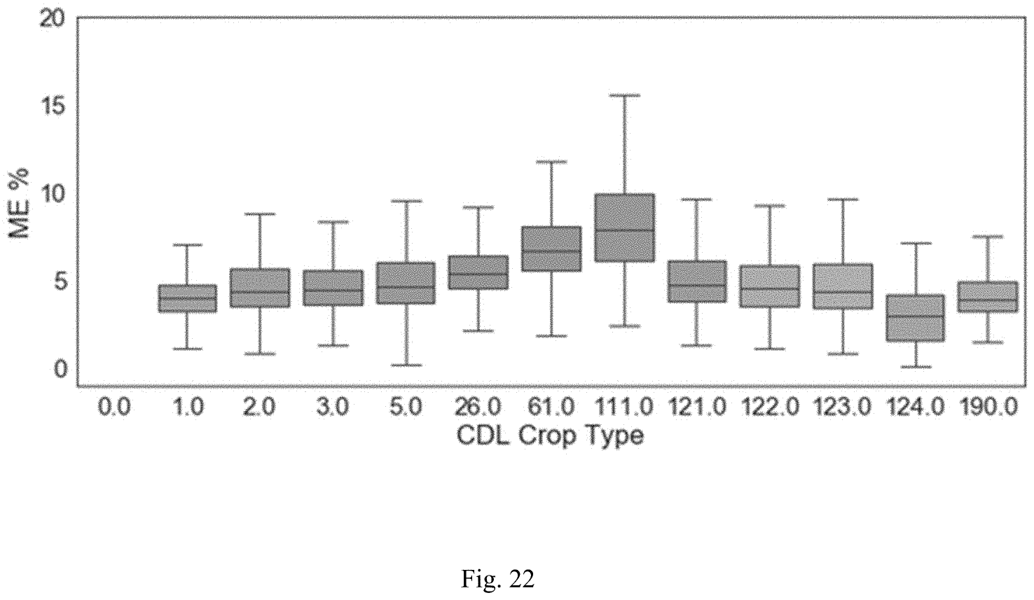

FIG. 22 shows error bars for mean error over multiple exemplary crop types according to embodiments of the present disclosure.

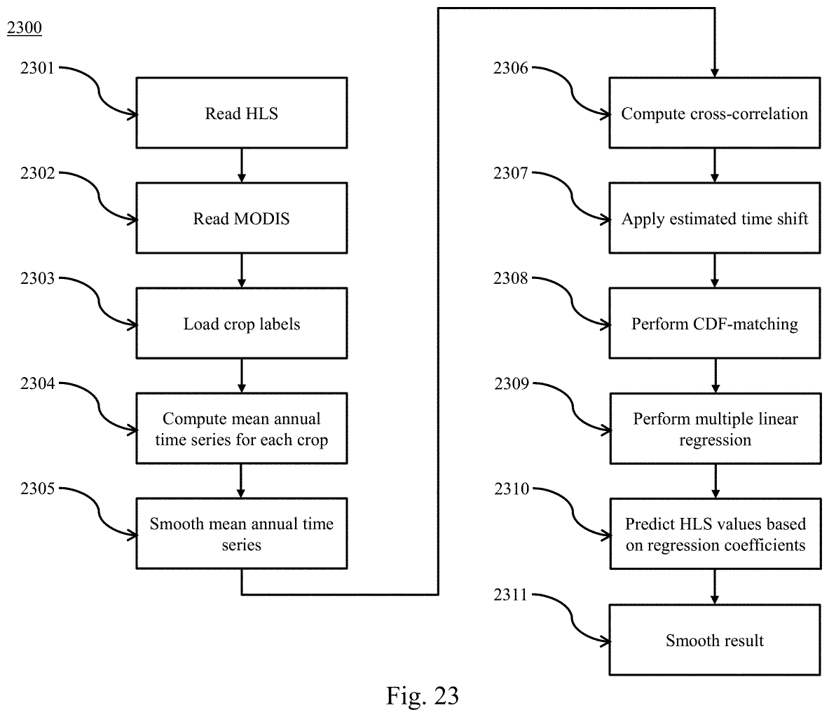

FIG. 23 illustrates a method of generating an imputed series according to embodiments of the present disclosure.

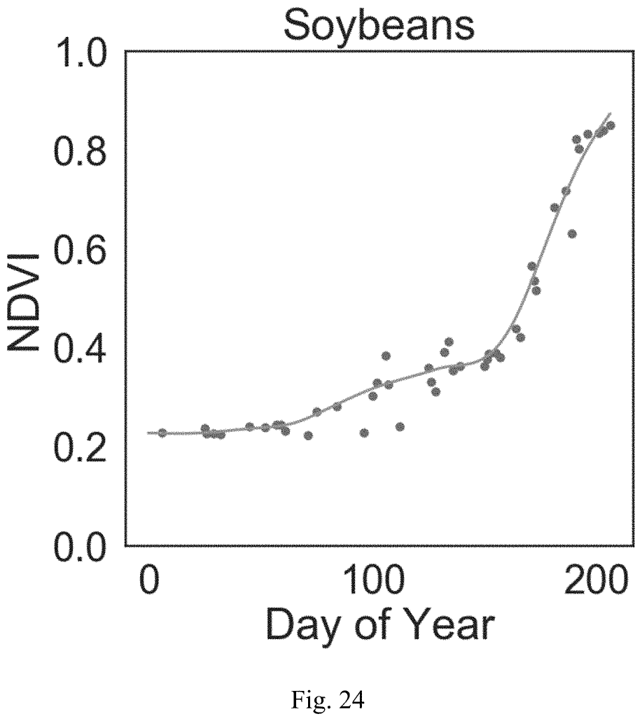

FIG. 24 illustrates an exemplary mean annual time series for soybeans according to embodiments of the present disclosure.

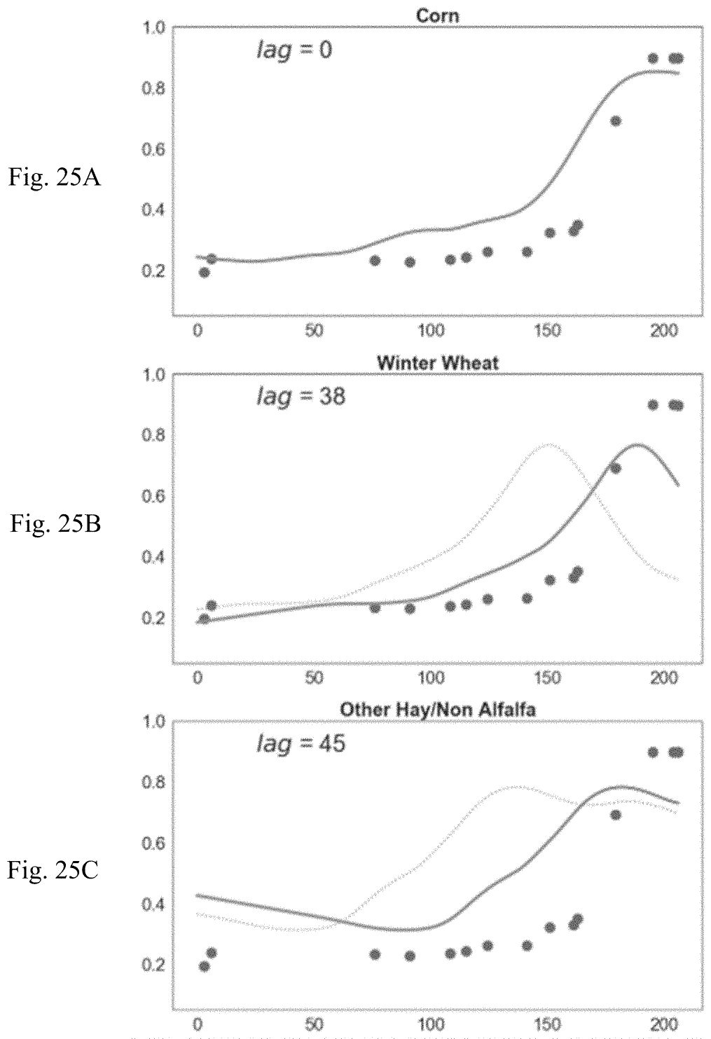

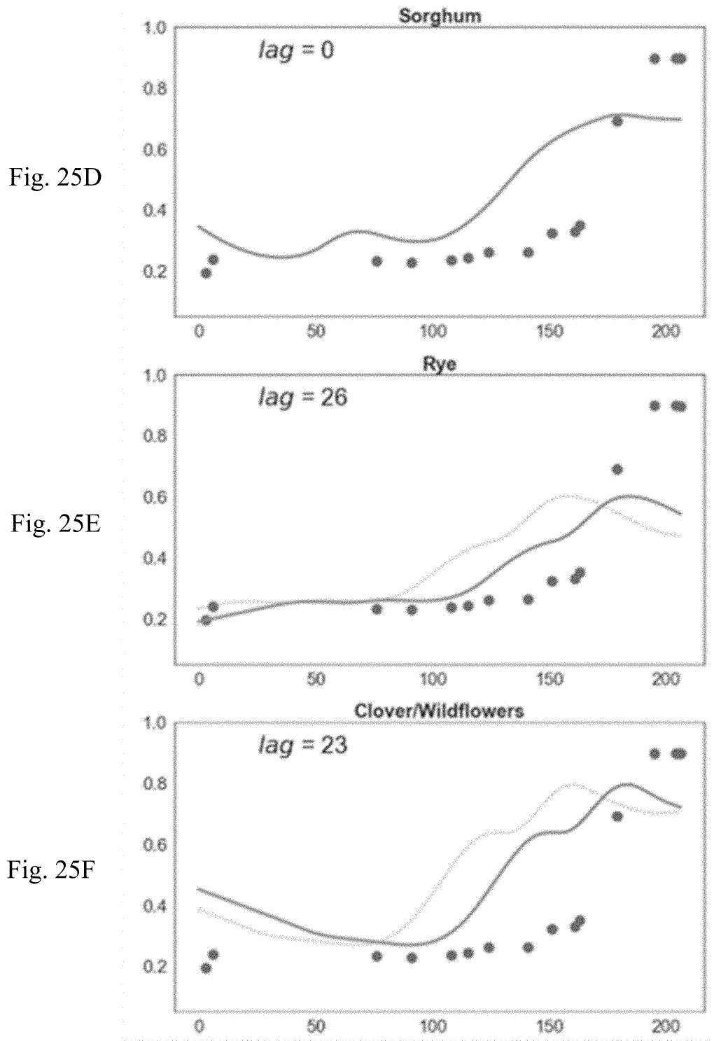

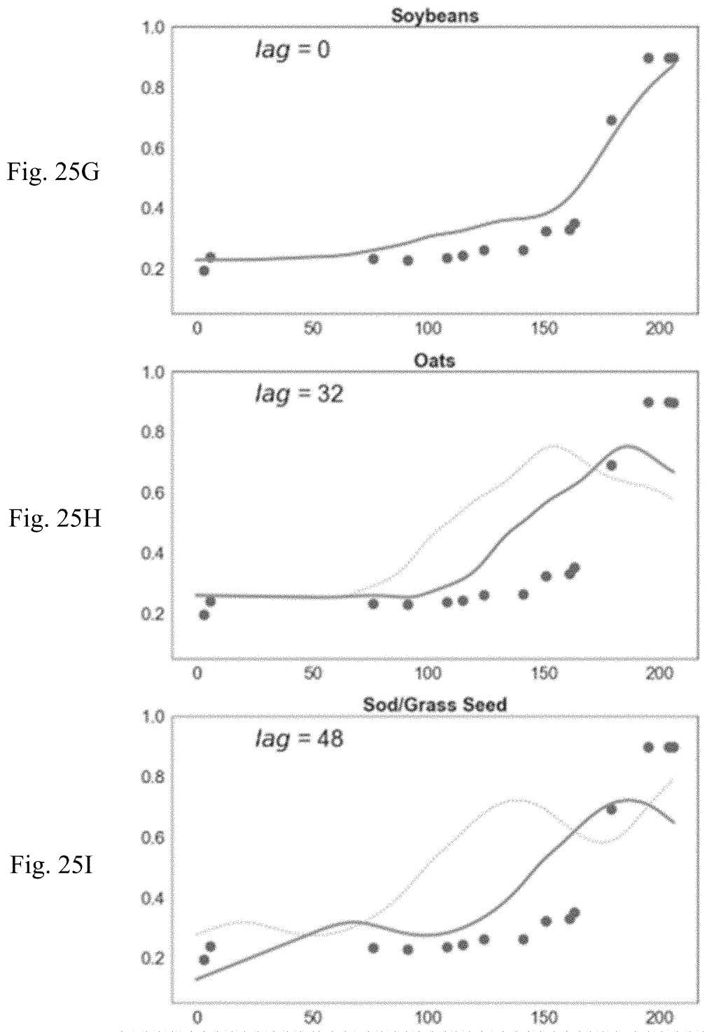

FIGS. 25A-I illustrate exemplary mean annual time series for a plurality of exemplary crop types and exemplary observed data according to embodiments of the present disclosure.

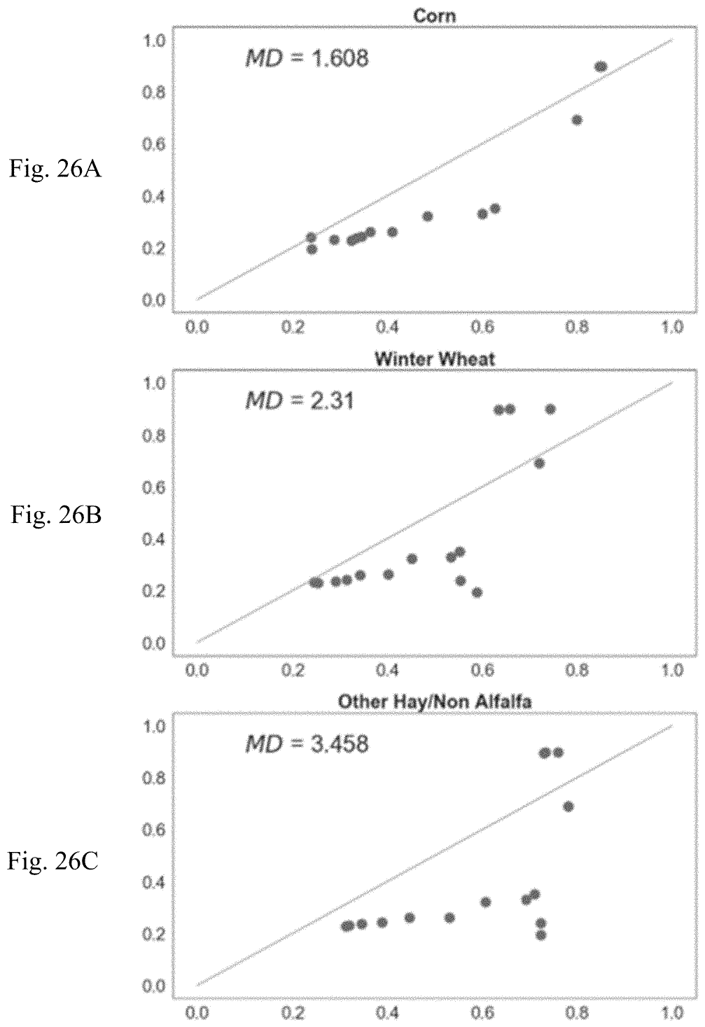

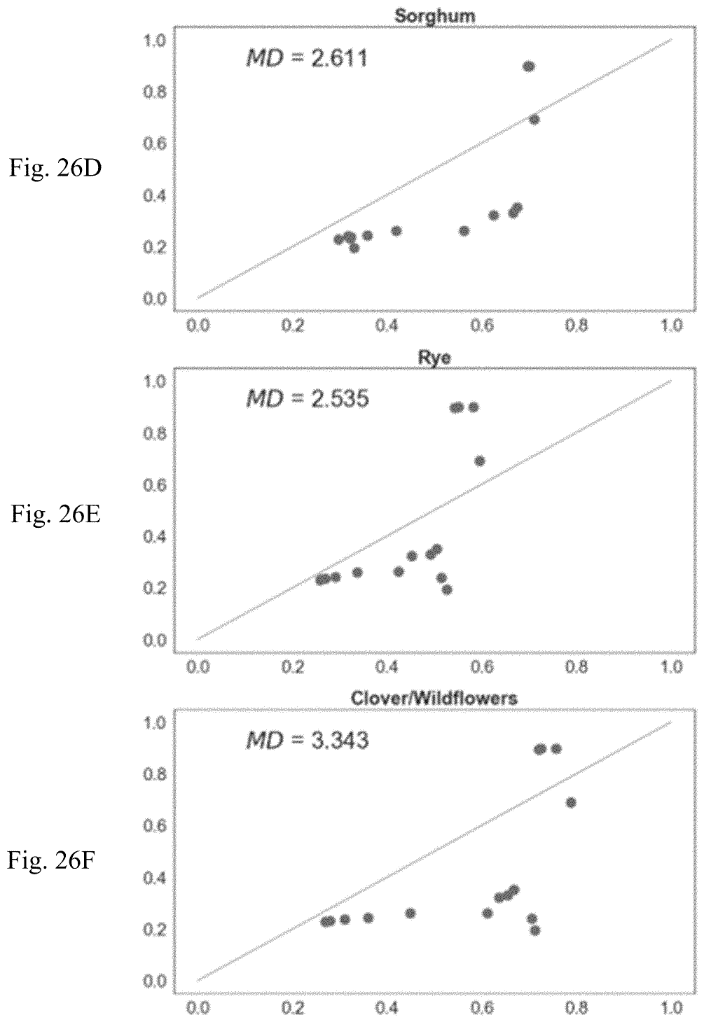

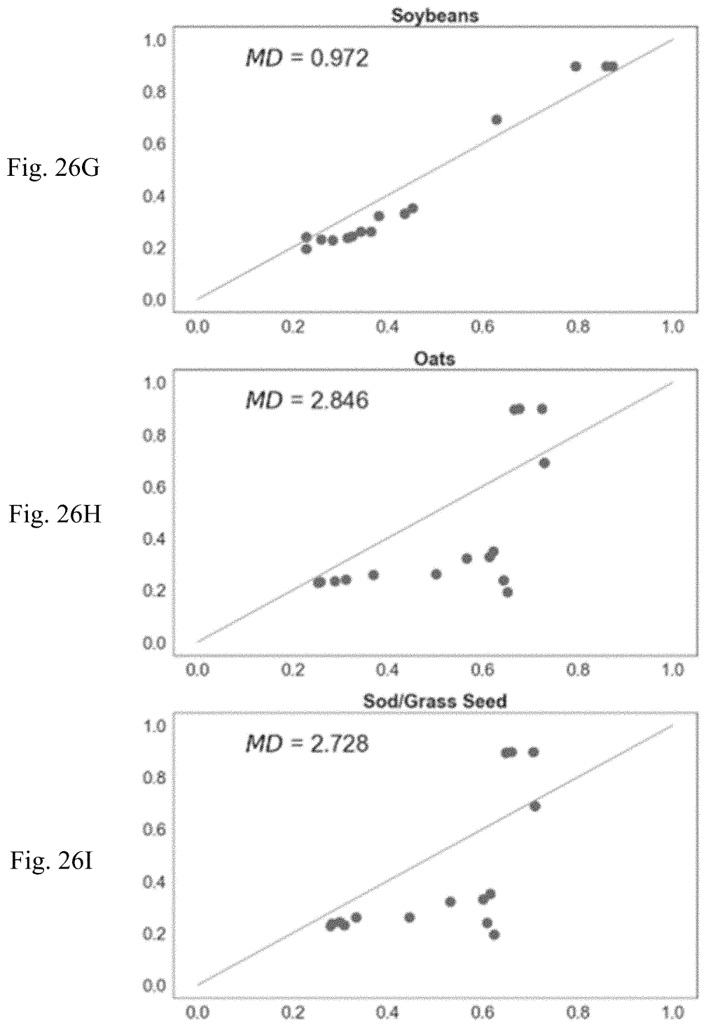

FIGS. 26A-I illustrate the Manhattan distance for various crop types and exemplary observed data according to embodiments of the present disclosure.

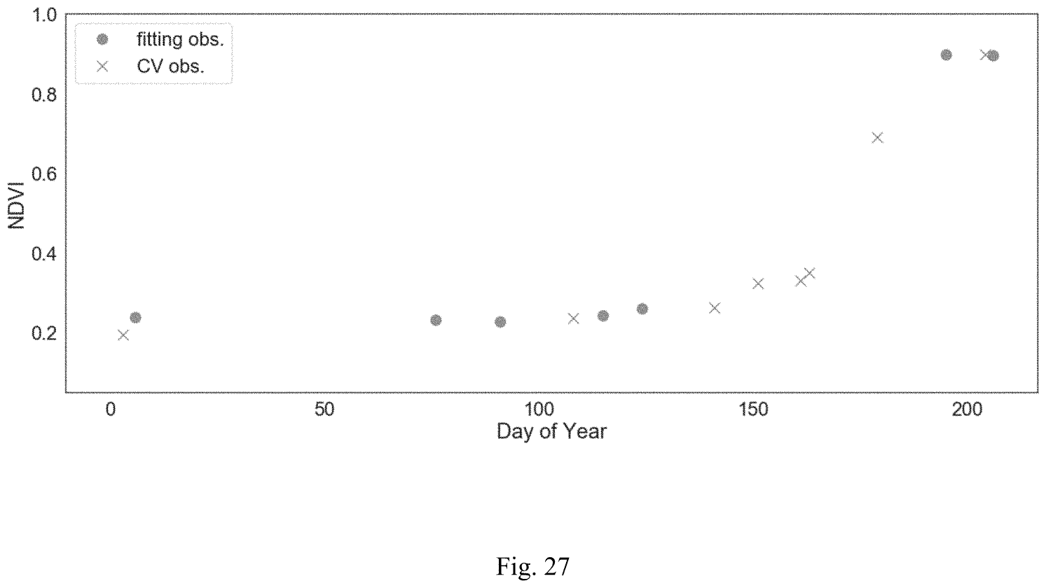

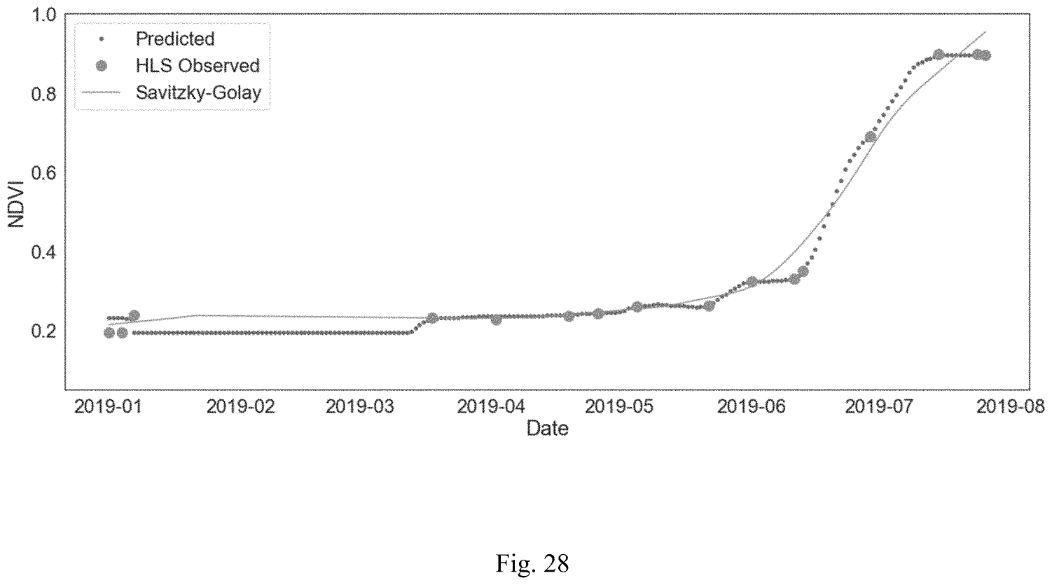

FIGS. 27-28 illustrate the results of cross-validation according to embodiments of the present disclosure.

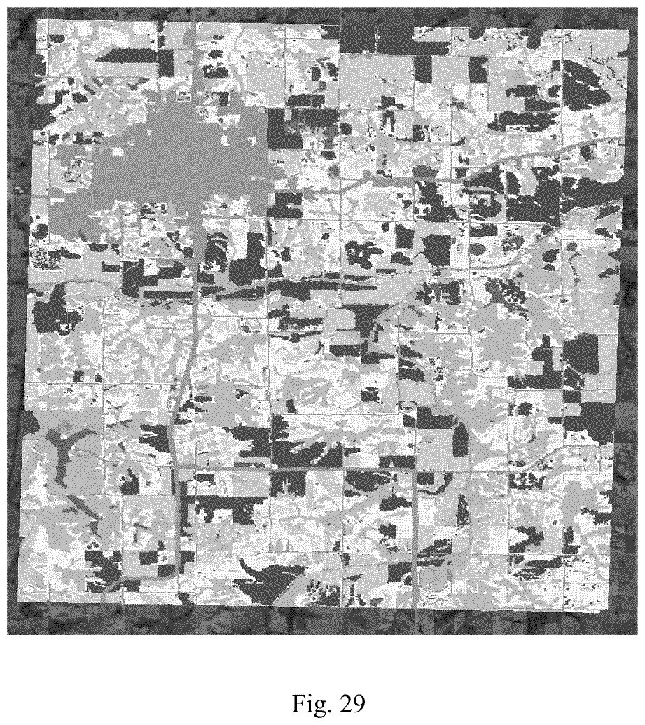

FIG. 29 shows an exemplary analysis tile according to embodiments of the present disclosure.

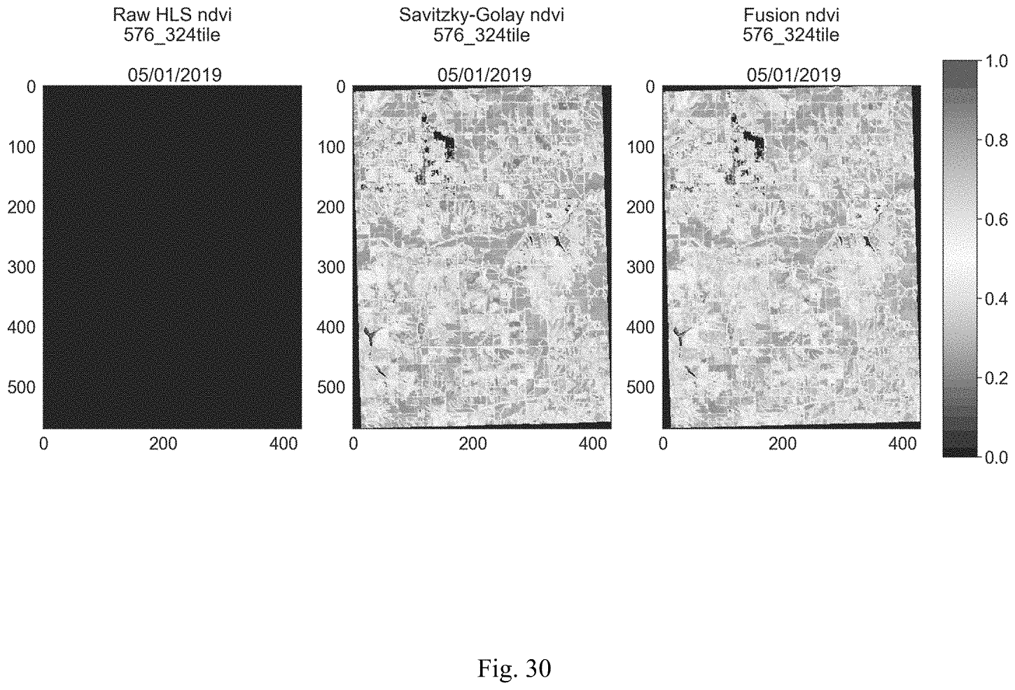

FIG. 30 illustrates exemplary results according to embodiments of the present disclosure for the tile of FIG. 29.

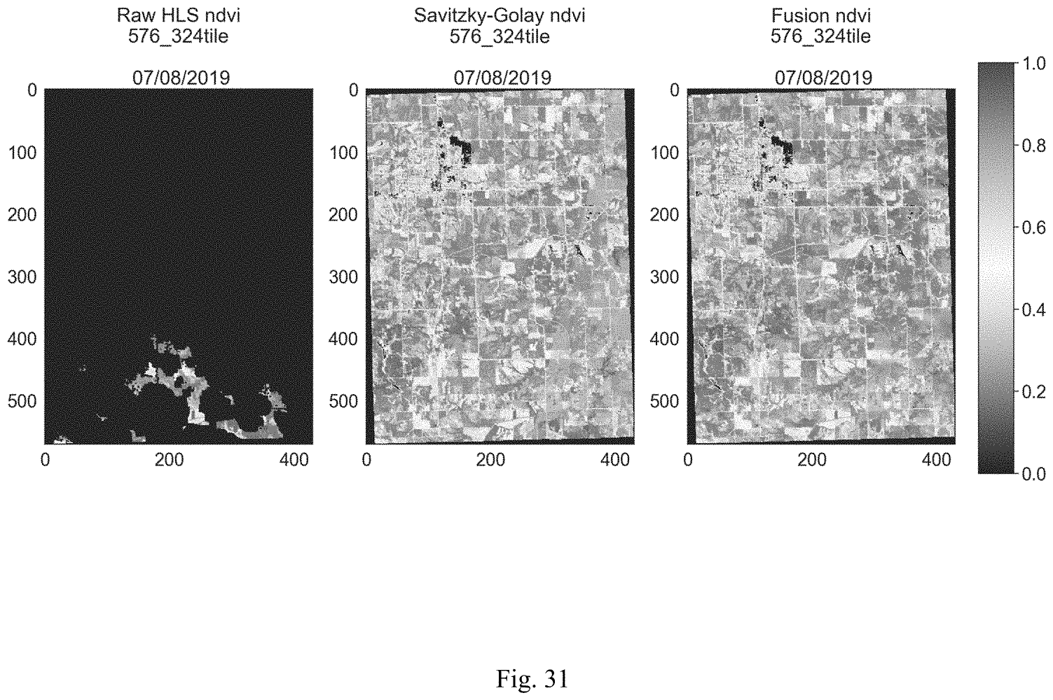

FIG. 31 illustrates exemplary results according embodiments of to the present disclosure for the tile of FIG. 29.

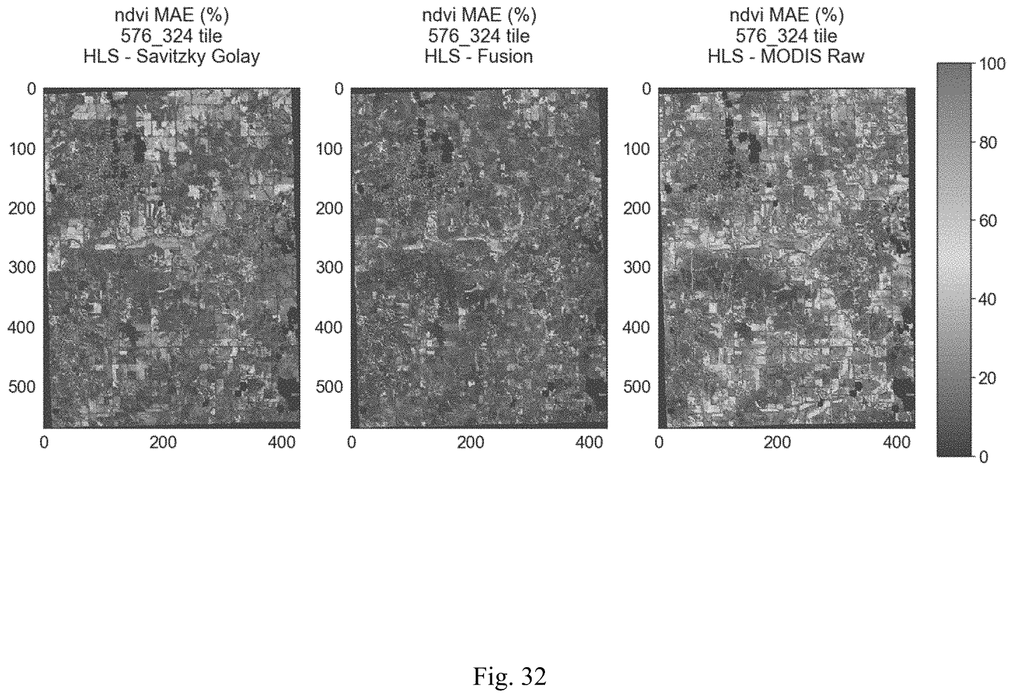

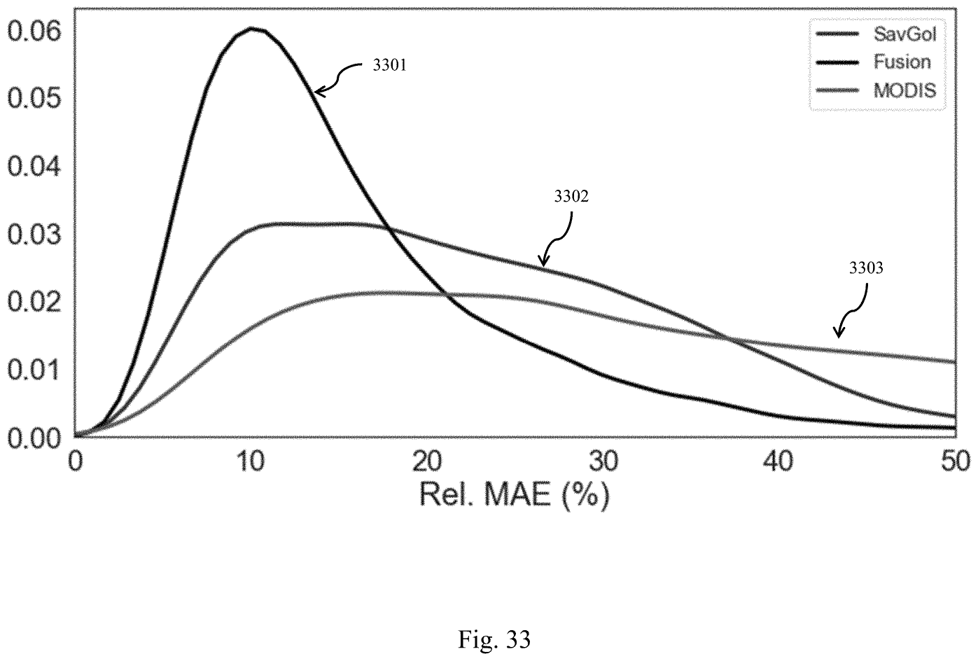

FIGS. 32-33 illustrate cross validation results according embodiments of to the present disclosure for the tile of FIG. 29.

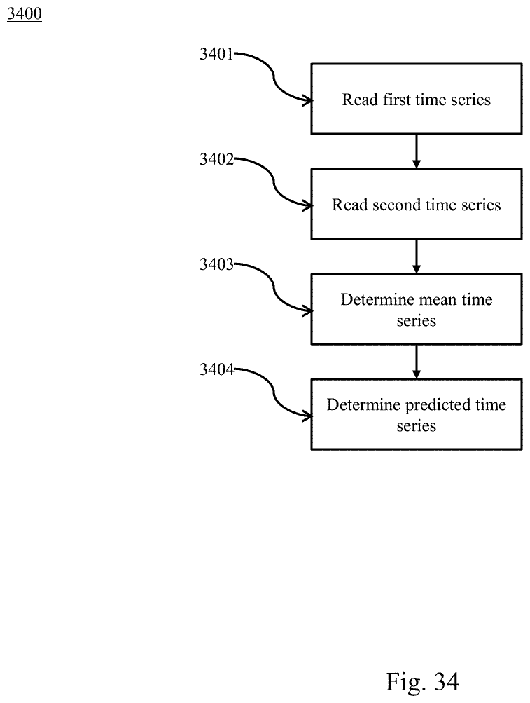

FIG. 34 illustrates a method for agricultural index prediction according to embodiments of the present disclosure.

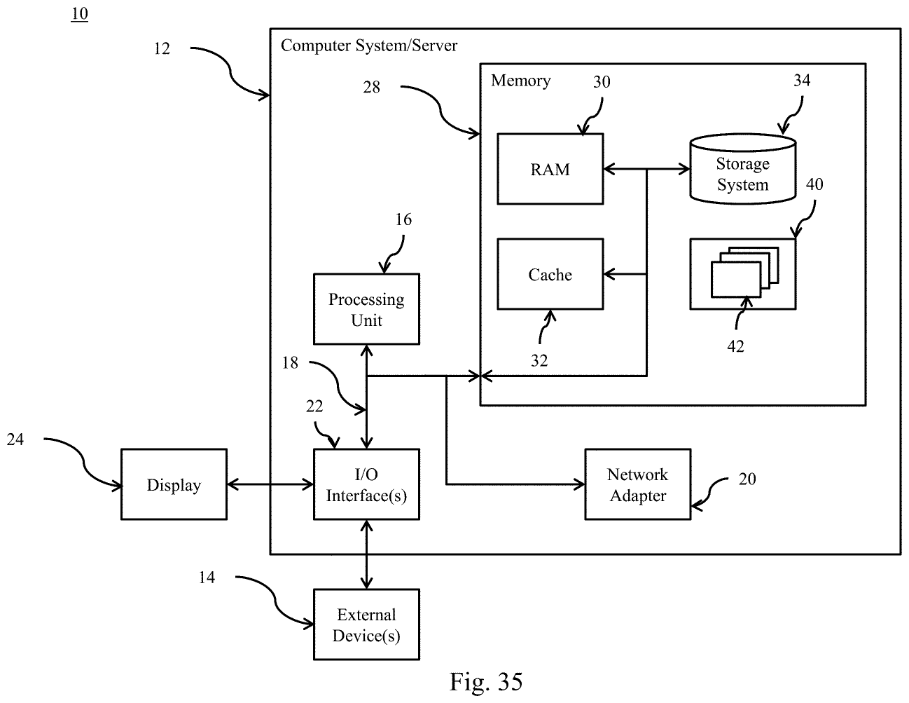

FIG. 35 depicts a computing node according to an embodiment of the present disclosure.

### DETAILED DESCRIPTION

Growers rely on frequently updated data layers in order to be proactive and informed with their daily decision-making, especially during the growing season. In addition to weather, satellite-derived vegetation indices such as NDVI can be a very useful source of information about crop health and growing stages.

The Harmonized Landsat Sentinel-2 (HLS) product provides observations at spatial resolutions high enough to resolve sub-field processes, but the latency remains on a weekly time scale given the overpass times of Landsat 8 and Sentinel-2 sensors, as well as cloud and snow coverage. On the other hand, MODIS-based imagery can be available daily, but the spatial resolution of 250+ m is too coarse to work on a field scale.

More generally, there exists a need to reconcile multimodal data where there is a tradeoff between frequency and resolution in order to arrive at a consistent and timely high-resolution combined product suitable for downstream processing such as agricultural index computation.

To address this and other needs in the art, the present disclosure provides statistical solutions based on the synthesis of MODIS and HLS data to generate vegetation indices with low latency and high spatial resolution. These approaches are suitable for supporting analysis and decision making for agriculture in near-real time. It will be appreciated that while various examples provided herein focus on MODIS and HLS, the present disclosure is applicable to other data sources where disparities are present between frequency and resolution.

In various embodiments, the statistical problem is isolated from the interpretation problem by focusing on the creation of an optimal but sensor-specific data set, upstream of analysis and modeling solutions. This allows creation of a daily, spatially comprehensive HLS time series that fills gaps due to missing imagery, or clouds and snow within available imagery.

In a first approach, interpolation is applied. In such embodiments, the value at a specific time is predicted based on the other values in a time series. In a second approach, statistical modeling is applied. Such embodiments utilize covariates available at a specific time, for example using the interpolated value plus CDF-transformed MODIS. In a third approach, spatial unmixing is applied. In such embodiments, mean annual time series for each crop type and co-located MODIS pixel are used. Combinations of these approaches can be used, e.g., the prediction from interpolation, then transformation of MODIS indices based on the co-located HLS time series and/or the mean HLS crop signal can be used in a statistical approach.

As set out below, a goodness of fit and out of sample error statistics are calculated to quantify the added value of each new approach through a cross-validation strategy. Predicted values are evaluated at a selected set of times and places for which HLS data are held out.

In addition to generating a comprehensive time-series of data based on prior years, the present disclosure is also applicable to generate in-season predictions, as set out below.

With reference now to FIG. 1, a general process for imputation of remote sensing time series is illustrated according to embodiments of the present disclosure. A first data source 101, containing higher resolution, lower frequency data 102, is read. In various embodiments, these data comprise one or more agricultural indices, such as the normalized difference vegetation index (NDVI) computed from satellite imagery, such as the Harmonized Landsat Sentinel-2 (HLS). HLS provides medium resolution imagery (approximately 30 m resolution) with low spatial mixing. HLS is available on an approximately weekly basis, and contains data gaps such as clouds and shadows.

A second data source 103, containing lower resolution, higher frequency data 104, is read. In various embodiments, these data comprise one or more agricultural indices, such as the normalized difference vegetation index (NDVI) computed from satellite imagery, such as the Moderate Resolution Imaging Spectroradiometer (MODIS). MODIS provides low resolution imagery (approximately 250 m resolution) with high spatial mixing. MODIS is available on an approximately daily basis.

In some embodiments, data source 101, 103 contain raw data from which indices may be computed. In such cases, it will be appreciated that indices may be computed before further computation.

All available data for a period of interest is retrieved from each available data source, resulting in temporally overlapping series 105, 106. Since it comes from the lower frequency data source, series 105 will contain fewer snapshots. Based on the higher-frequency, lower-resolution series 106, and the lower-frequency, higher-resolution series 105, a combined series 107 is generated having both the higher frequency and the higher resolution.

In various embodiments, each series comprises one or more indices for each point in time for which data is available at each pixel in a region of interest. Various indices, for example, normalized difference vegetation index (NDVI), land surface water index (LSWI), and mean brightness (BRT), may be used. Each snapshot in a series is a raster, or image, whose pixel intensity indicates the index value.

Referring to FIG. 2, a method of generating an imputed series is illustrated according to the present disclosure. At 201, for each pixel in a region of interest, all available HLS observations for a predetermined period (e.g., a year) are loaded. At 202, for each pixel in a region of interest, all available MODIS observations for a predetermined period (e.g., a year) are loaded. In various embodiments, the raw satellite data are loaded and indices are computed, while in some embodiments, precomputed indices are loaded. At 203, the MODIS data is gap filled using linear interpolation. At 204, the MODIS data are extracted that correspond to the available days of HLS data. At 205, an empirical cumulative distribution function (ECDF) is built for HLS and MODIS. At 206, the MODIS ECDF is mapped to the HLS ECDF using a linear interpolation. At 207, the value of the MODIS observation is scaled up or down using that mapping function. At 208, the resulting time series is smoothed to reduce noise.

Referring to FIG. 3, an example of cumulative distribution function (CDF) matching for a given pixel is illustrated. For this pixel, a MODIS NDVI value of 0.68 will be shifted to 0.82 based on the HLS ECDF. It will be appreciated that while various examples provided herein use an empirical cumulative distribution function (ECDF), alternative methods of determining a cumulative distribution function (CDF) may be used in accordance with the present disclosure.

Referring to FIGS. 4A-B, a graph is provided of NDVI over time as observed and as derived for a given pixel. In this example, the pixel is 10000 in tile 599_361 and the graph is split over two sheets. In particular, the graph shows each observed value as a dot, with HLS corrected MODIS, both smoothed and unsmoothed, shown as solid lines. Running the CDF-matching algorithm took about 500 seconds for one tile/year without smoothing, and about 700 s with smoothing. In this example, every pixel in the tile is computed separately, which is computationally expensive. In alternative embodiments, the data is vectorized, allowing greater efficiency in computation.

Referring to FIG. 5A, raw MODIS NDVI for an exemplary region is shown. In FIG. 5B, the corresponding corrected MODIS NDVI is shown.

Referring to FIG. 6A, raw MODIS NDVI for the same exemplary region is shown for a different date. In FIG. 6B, corresponding raw HLS NDVI is shown. In FIG. 6C, the ECDF-matched MODIS NDVI is shown.

Referring to FIG. 7A, the r² values for HLS versus CDF-matched MODIS NDVI are shown. In FIG. 7B, the corresponding mean error is shown.

Referring now to FIG. 8, a method of generating an imputed series is illustrated according to the present disclosure. At 801, for each pixel in a region of interest, all available HLS observations for a predetermined period (e.g., a year) are loaded. At 802, for each pixel in a region of interest, all available MODIS observations for a predetermined period (e.g., a year) are loaded. In various embodiments, the raw satellite data are loaded and indices are computed, while in some embodiments, precomputed indices are loaded.

At 803, crop labels are loaded. In some embodiments, crop type labels are drawn from the NASS Cropland Data Layer (CDL). In some embodiments, the crop type labels are associated with the same predetermined period (e.g., a year) as the observed data.

At 804, a mean annual time series is computed from the HLS data for each crop type in the region of interest. In some embodiments, the HLS data is masked using the crop type labels as masks in order to determine the subsets of the HLS data containing each crop type. At 805, the mean annual time series are smoothed, for example using a cubic spline. At 806, multiple linear regression is performed using the mean crop type with the MODIS pixel time series as independent variables and observed HLS time series as the dependent variable. At 807, the HLS values are predicted using the regression coefficients resulting from the multiple linear regression. At 808, a cubic smoothing spline is fit through the predicted HLS observations.

In various embodiments, a library of mean annual time series is generated. Such a library contains a mean annual curve for each of a plurality of crop types for each of a plurality of regions. For example, a curve may be generated for each crop type in each 0.5 degree region of the Earth's surface. The library of curves may be used as described above for determining the predicted HLS value when a crop type is known.

In addition, predicted HLS values may be determined when a crop type is not known. Crop-specific priors are computed for an arbitrary time window using all available HLS NDVI data and associated CDL maps. The observed HLS time series is compared with each crop-specific prior using Manhattan Distance (MD). The crop with the minimum MD is chosen and this time series and MODIS time series are used as independent variables in multivariate linear regression according to Equation 1. In addition to allowing determination of predicted HLS values this allows enables in-season crop detection, where the detected crop type is inferred from the crop-specific prior having the least Manhattan distance, as described above.

HLS=β₀β₁Mean+β₂MODIS+ϵ (1)

Referring to FIGS. 9-12, exemplary mean annual time series are shown for a plurality of exemplary crop types. In these figures, the y-axis corresponds to NDVI value, and the x-axis corresponds to days.

Referring to FIG. 13, exemplary predicted HLS values are shown. Actual HLS observations are shown as large dots, while predicted values are shown as small dots.

Referring to FIG. 14, graph is provided of NDVI over time as observed and as derived for a given pixel and a given crop. In particular, the graph shows observed HLS values as dots, HLS crop mean values as xs, and MODIS as a solid line.

Referring to FIG. 15A, a graph is provided illustrating the correlation between HLS observations of NDVI and mean crop time series. In FIG. 15B, a graph is provided illustrating the correlation between HLS observations of NDVI and co-located MODIS observations.

Referring to FIG. 16, a graph is provided illustrating the observed versus predicted HLS NDVI based on multiple regression coefficients.

Referring to FIG. 17, a graph is provided illustrating the observed versus HLS NDVI time series.

Running the spatial unmixing algorithm on a single analysis tile takes approximately 600-700 seconds. In this example, every pixel in the tile is computed separately, which is computationally expensive. In alternative embodiments, the data is vectorized, allowing greater efficiency in computation.

Referring to FIG. 18A, raw MODIS NDVI for an exemplary region is shown. In FIG. 18B, the corresponding corrected MODIS NDVI is shown.

Referring to FIG. 19, raw corrected NDVI for the same exemplary region is shown for a different date.

Referring to FIG. 20A, the r² values for HLS versus linear unmixing NDVI are shown. In FIG. 20B, the corresponding mean error is shown. Referring to FIG. 21, error bars are shown for r² over multiple exemplary crop types. Referring to FIG. 22, error bars are shown for mean error over multiple exemplary crop types.

In various embodiments, a hybrid approach between the linear unmixing and CDF matching is adopted. The linear unmixing approach described above cleans the crop signal, and provides a high quality approximation of the HLS, yielding both a good visual match and high r². The approach relies on a CDL mask, and provides gap filling with a spline smoother. CDF-matching, by comparison, does not clean the crop signal. While good at approximating HLS, linear unmixing provides a higher quality output. It does not rely on any masks, and provides only limited gap-filling through the linear gap filling done to the raw MODIS time series.

In an exemplary hybrid approach, CDF matching is applied on MODIS, and then linear unmixing is performed. This approach cleans the original MODIS, improves over the linear unmixing performance, relies on CDL, and provides only the limited gap filling done to the raw MODIS time series. This may be advantageous for both historical products, and for in-season estimates before any crop mask becomes available.

Referring now to FIG. 23, a method of generating an imputed series is illustrated according to the present disclosure. At 2301, for each pixel in a region of interest, all available HLS observations for a predetermined period (e.g., a year) are loaded. At 2302, for each pixel in a region of interest, all available MODIS observations for a predetermined period (e.g., a year) are loaded. In various embodiments, the raw satellite data are loaded and indices are computed, while in some embodiments, precomputed indices are loaded.

At 2303, crop labels are loaded. In some embodiments, crop type labels are drawn from the NASS Cropland Data Layer (CDL). In some embodiments, the crop type labels are associated with the same predetermined period (e.g., a year) as the observed data.

At 2304, a mean annual time series is computed from the HLS data for each crop type in the region of interest. In some embodiments, the HLS data is masked using the crop type labels as masks in order to determine the subsets of the HLS data containing each crop type. At 2305, the mean annual time series are smoothed, for example using a cubic spline.

At 2306, a cross-correlation is computed between an observed HLS time series and the mean crop-specific time series to estimate any time shift resulting from weather or agricultural management practices. At 2307, the estimated time shift is applied to the mean crop time series in order to adjust it for weather or agricultural management practices.

At 2308, CDF matching is applied on the MODIS data, for example as described above, to rescale the observed MODIS data.

At 2309, multiple linear regression is performed using the mean crop type (as time-shifted) with the MODIS pixel time series (as rescaled by CDF matching) as independent variables and observed HLS time series as the dependent variable. At 2310, the HLS values are predicted using the regression coefficients resulting from the multiple linear regression. At 2311, a cubic smoothing spline is fit through the predicted HLS observations.

It will be appreciated that while the above example includes computation and application of a time-shift, in additional embodiments these steps may be omitted. Likewise, while the above example includes CDF-matching of MODIS data, in additional embodiments, this step may be omitted.

In various embodiments, a library of mean annual time series is generated. Such a library contains a mean annual curve for each of a plurality of crop types for each of a plurality of regions. For example, a curve may be generated for each crop type in each 0.5 degree region of the Earth's surface. The library of curves may be used as described above for determining the predicted HLS value when a crop type is known.

In addition, predicted HLS values may be determined when a crop type is not known. Crop-specific priors are computed for an arbitrary time window using all available HLS NDVI data and associated CDL maps. The observed HLS time series is compared with each crop-specific prior using Manhattan Distance (MD). The crop with the minimum MD is chosen and this time series and MODIS time series are used as independent variables in multivariate linear regression according to Equation 1. In addition to allowing determination of predicted HLS values this allows enables in-season crop detection, where the detected crop type is inferred from the crop-specific prior having the least Manhattan distance, as described above.

Referring to FIG. 24, an exemplary mean annual time series is provided for soybeans, computed as described above.

Referring to FIGS. 25A-I, exemplary mean annual time series are shown for a plurality of exemplary crop types and exemplary observed data. In this example, both the time adjusted (solid) and original (dotted) mean annual time series are shown, which are determined as set forth above. In these figures, the y-axis corresponds to NDVI value, and the x-axis corresponds to days.

Referring to FIGS. 26A-I, the Manhattan distance for each crop type and the exemplary observed data are shown. In this example, the minimum Manhattan distance correspond to soybeans (FIG. 26G), indicating that this is crop reflected in the exemplary data illustrated. In these figures, the y-axis corresponds to NDVI value, and the x-axis corresponds to days.

Referring to FIGS. 27-28, the results of cross-validation are shown. In FIG. 27, the fitting observations of the exemplary data are shown as filled circles. The random sample of HLS observations withheld for accuracy testing are shown as exes. In FIG. 28, the observed values and predicted values (computed as set forth above) are compared to the results of a Savitzky-Golay filter.

Referring now to FIG. 29, an exemplary analysis tile is provided. This tile measures 0.15°×0.15°, and is located in south central Iowa. Scanline artifacts are present in the 2019 monthly NDVI composites. The area is largely corn and soy with neighboring pasture and forest.

FIG. 30 illustrates results according to the present disclosure for the tile of FIG. 29 on May 1, 2019. In particular, FIG. 30 juxtaposes the raw HLS NDVI values with the values resulting from a Savitzky-Golay filter and those obtained applying the methods described herein.

FIG. 31 illustrates results according to the present disclosure for the tile of FIG. 29 on Jul. 8, 2019. In particular, FIG. 31 juxtaposes the raw HLS NDVI values with the values resulting from a Savitzky-Golay filter and those obtained applying the methods described herein.

Referring to FIGS. 32-33, cross validation results are shown for the tile of FIG. 29. In particular, FIG. 32 juxtaposes the mean absolute error (MAE) for a Savitzky-Golay filter, the methods described herein, and raw MODIS. The MAE is charted in FIG. 33, where 3301 corresponds to the methods described herein (denoted Fusion), 3302 corresponds to a Savitzky-Golay filter (denoted SavGol), and 3303 corresponds to raw MODIS (denoted MODIS).

As set out above, the present disclosure provides a temporally-driven, pixel-wise fusion approach using a multi-year HLS record. These methods exhibit improved cross-validation results relative to a Savitzky-Golay filter. These improved results enhance data-driven agricultural products such as crop type mapping, compositing, and field boundary delineation.

Referring to FIG. 34, a method agricultural index prediction is illustrated according to embodiments of the present disclosure. At 3401, a first time series of raster data is read. The first time series spans a geographic region and has a first resolution and a first frequency. At 3402, a second time series of raster data is read. The second time series spans the geographic region and has a second resolution and a second frequency. The second resolution is lower than the first resolution. The second frequency is higher than the first frequency. At 3403, a mean time series is determined from the first time series of raster data. At 3404, a predicted time series of values for a location within the geographic region is determined at the first resolution by determining a first time series of values for the location from the first time series of raster data, determining a second time series of values of the location from the second time series of raster data, and determining the predicted time series by multiple linear regression with the first time series dependent on the mean time series and the second time series.

Referring now to FIG. 35, a schematic of an example of a computing node is shown. Computing node 10 is only one example of a suitable computing node and is not intended to suggest any limitation as to the scope of use or functionality of embodiments described herein. Regardless, computing node 10 is capable of being implemented and/or performing any of the functionality set forth hereinabove.

In computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 35, computer system/server 12 in computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus, Peripheral Component Interconnect Express (PCIe), and Advanced Microcontroller Bus Architecture (AMBA).

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the disclosure.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

The present disclosure may be embodied as a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
reading a first time series of raster data, the first time series spanning a geographic region and having a first resolution and a first frequency;
reading a second time series of raster data, the second time series spanning the geographic region and having a second resolution and a second frequency, the second resolution being lower than the first resolution, and the second frequency being higher than the first frequency;
determining a mean time series from the first time series of raster data; and
determining a predicted time series of values for a location within the geographic region at the first resolution by
determining a first time series of values for the location from the first time series of raster data,
determining a second time series of values of the location from the second time series of raster data, and
determining the predicted time series by multiple linear regression with the first time series dependent on the mean time series and the second time series.

2. The method of claim 1, further comprising:
smoothing the mean time series.

3. The method of claim 1, further comprising:
smoothing the predicted time series of values.

4. The method of claim 1, wherein each of the first time series of raster data, the second time series of raster data, the mean time series, and the predicted time series correspond to an agricultural index.

5. The method of claim 4, wherein the agricultural index comprises normalized difference vegetation index, land surface water index, or and mean brightness.

6. The method of claim 1, further comprising:
reading a crop type mask, wherein
determining the mean time series comprises masking the first time series of raster data according to the crop type mask.

7. The method of claim 1, further comprising:
reading a plurality of crop type masks; and
determining a plurality of mean time series from the first time series of raster data, each mean time series corresponding to one of the plurality of crop type masks,
wherein determining each mean time series comprises masking the first time series of raster data according to the respective crop type mask.

8. The method of claim 7, wherein determining the mean time series comprises selecting the mean time series from the plurality of mean time series.

9. The method of claim 7, wherein determining the mean time series comprises selecting one of the plurality of mean time series most similar to the first time series of values.

10. The method of claim 9, further comprising:
determining a crop type associated with the selected one of the plurality of mean time series.

11. The method of claim 1, further comprising:
applying a time shift to the mean time series based on the first time series.

12. The method of claim 11, further comprising:
determining the time shift by cross-correlation between the mean time series and the first time series.

13. The method of claim 1, further comprising:
rescaling the second time series.

14. The method of claim 13, wherein rescaling the second time series comprises CDF matching.

15. A system comprising:
a computing node comprising a computer readable storage medium having program instructions embodied therewith, the program instructions executable by
a processor of the computing node to cause the processor to perform a method comprising:
reading a first time series of raster data, the first time series spanning a geographic region and having a first resolution and a first frequency;
reading a second time series of raster data, the second time series spanning the geographic region and having a second resolution and a second frequency, the second resolution being lower than the first resolution, and the second frequency being higher than the first frequency;
determining a mean time series from the first time series of raster data; and
determining a predicted time series of values for a location within the geographic region at the first resolution by
determining a first time series of values for the location from the first time series of raster data,
determining a second time series of values of the location from the second time series of raster data, and
determining the predicted time series by multiple linear regression with the first time series dependent on the mean time series and the second time series.

16. A computer program product for agricultural index prediction, the computer program product comprising a computer readable storage medium having program instructions embodied therewith, the program instructions executable by a processor to cause the processor to perform a method comprising:
reading a first time series of raster data, the first time series spanning a geographic region and having a first resolution and a first frequency;
reading a second time series of raster data, the second time series spanning the geographic region and having a second resolution and a second frequency, the second resolution being lower than the first resolution, and the second frequency being higher than the first frequency;
determining a mean time series from the first time series of raster data; and
determining a predicted time series of values for a location within the geographic region at the first resolution by
determining a first time series of values for the location from the first time series of raster data,
determining a second time series of values of the location from the second time series of raster data, and
determining the predicted time series by multiple linear regression with the first time series dependent on the mean time series and the second time series.

17. The computer program product of claim 16, the method further comprising:
reading a plurality of crop type masks; and
determining a plurality of mean time series from the first time series of raster data, each mean time series corresponding to one of the plurality of crop type masks,
wherein determining each mean time series comprises masking the first time series of raster data according to the respective crop type mask.

18. The computer program product of claim 17, wherein determining the mean time series comprises selecting the mean time series from the plurality of mean time series.

19. The computer program product of claim 17, wherein determining the mean time series comprises selecting one of the plurality of mean time series most similar to the first time series of values.

20. The computer program product of claim 19, the method further comprising:
determining a crop type associated with the selected one of the plurality of mean time series.
